(19) United States
(12) Patent Application Publication
(10) Pub. No.: US 2026/0202918 A1
(43) Pub. Date: Jul. 16, 2026

(54) PROJECTOR AND METHOD OF OPERATING THE SAME

(71) Applicant: Samsung Electronics Co., Ltd., Suwon-si (KR)

(72) Inventors: Seungik LEE, Suwon-si (KR); Jaeyong KIM, Suwon-si (KR); Minsup KIM, Suwon-si (KR); Sejun KIM, Suwon-si (KR); Jongjin PARK, Suwon-si (KR)

(21) Appl. No.: 19/372,912

(22) Filed: Oct. 29, 2025

Related U.S. Application Data
(63) Continuation of application No. PCT/KR2025/014551, filed on Sep. 18, 2025.

(30) Foreign Application Priority Data
Jan. 13, 2025 (KR) 10-2025-0004776

(51) Int. Cl. G06F 3/03; G06F 3/042

(52) U.S. Cl. CPC G06F 3/0325; G06F 3/0423

(57) ABSTRACT

The disclosure relates to a projector capable of adjusting a user touch area by adjusting an IR irradiation angle and a method of operating the same. The projector may irradiate IR to generate an IR irradiation area in a horizontal direction on a projection plane, determine whether IR reflection is detected in the IR irradiation area in a predetermined operation mode, and based on IR reflection being detected, adjust an IR irradiation angle so that IR reflection is not detected in the IR irradiation area.

### CROSS-REFERENCE TO RELATED APPLICATIONS

This application is a continuation of International Application No. PCT/KR2025/014551 designating the United States, filed on September 18, 2025, in the Korean Intellectual Property Receiving Office and claiming priority to Korean Patent Application No. 10-2025-0004776, filed on January 13, 2025, in the Korean Intellectual Property Office, the disclosures of each of which are incorporated by reference herein in their entireties.

### BACKGROUND

### Field

The disclosure relates to a projector capable of adjusting a user touch area and a method of operating the same.

### Description of Related Art

A projector is a device that displays by projecting an image onto a screen (or a projection plane) at a predetermined distance from itself. A general projector requires a long projection distance to form a large-sized image on a large screen, and there is a problem that an image is blocked when a person passes through a large space due to the projection distance between the projector and the screen. Accordingly, demand for an ultra-short throw (UST) projector (or a UST projector) that may project a large image even close to a screen by having a large angle of view is increasing. In addition to a function of projecting an image in an ultra-short throw projector, functions of interacting through a user touch input on a projection screen are also required. In this case, it is necessary to provide a projection screen and a user touch area by minimizing or reducing the influence of the installation environment of the projector (e.g., a projector installation table).

### SUMMARY

Embodiments of the disclosure provide a projector capable of adjusting a user touch area and a method of operating the same. For example, various embodiments of the disclosure relate to a projector capable of adjusting a user touch area by adjusting an IR irradiation angle to normally generate an IR irradiation surface when an infrared (IR) irradiation surface is not normally generated due to the curvature of a projector projection floor surface, and a method of operating the same.

According to an example embodiment of the disclosure, a projector may include: a projection unit, including circuitry, configured to project an image onto a projection plane, an IR emitter, comprising circuitry, configured to generate an IR irradiation area in a horizontal direction on the projection plane, at least one sensor configured to sense the projection plane or the IR irradiation area, a memory storing at least one instruction, and at least one processor, comprising processing circuitry, electrically connected to the projection unit, the IR emitter, the at least one sensor and the memory, wherein at least one processor, individually and/or collectively, is configured to execute the at least one instruction and to cause the projector to: determine whether IR reflection is detected in the IR irradiation area in a specified operation mode and, based on IR reflection being detected, adjust an irradiation angle of the IR emitter or adjust a height of the IR emitter so that IR reflection is not detected in the IR irradiation area.

According to an example embodiment of the disclosure, a method of operating a projector may include: irradiating IR to generate an IR irradiation area in a horizontal direction on a projection plane, determining whether IR reflection is detected in the IR irradiation area in a specified operation mode, and based on IR reflection being detected, adjusting an irradiation angle of an IR emitter or adjusting a height of the IR emitter so that IR reflection is not detected in the IR irradiation area.

According to an example embodiment of the disclosure, there may be included a non-transitory computer-readable recording medium recording a program for performing the method.

According to various example embodiments of the disclosure, by optimizing and adjusting an IR irradiation angle (or slope) so as not to be affected by the curvature of a projector projection floor surface, constraints of a projector installation environment such as the curvature of a projector projection table may be alleviated.

According to various example embodiments of the disclosure, by setting an optimized IR irradiation angle that is not affected by a projector projection floor surface to calibrate a user touch area, the constraint of having to reduce a screen projection area because a user touch area is not normally generated due to the curvature of a projection floor surface may be addressed, and through this, an effect of enhancing user experience and product value of a UST projector may be provided.

Effects achievable by the disclosure are not limited to the above-mentioned effects, but other effects not mentioned may be apparently derived and understood by one of ordinary skill in the art to which example embodiments of the disclosure pertain, from the following description.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a diagram illustrating an example projector projecting an image and irradiating IR toward a floor surface according to various embodiments;

FIG. 2 is a diagram illustrating an example of use of a projector according to various embodiments;

FIG. 3 is a diagram illustrating an example in which an IR irradiation surface is not normally generated according to various embodiments;

FIG. 4 is a diagram illustrating an example IR emitter irradiating IR according to various embodiments;

FIG. 5 is a diagram illustrating an example in which an IR emitter generates an IR irradiation area on a floor surface without curvature according to various embodiments;

FIG. 6 is a diagram illustrating an example of a floor surface with curvature according to various embodiments;

FIG. 7 is a diagram illustrating an example in which an IR emitter generates an IR irradiation area on the floor surface with curvature illustrated in FIG. 6 according to various embodiments;

FIG. 8 is a diagram illustrating examples of various floor surfaces where a projector is positioned according to various embodiments;

FIGS. 9 and 10 are perspective views illustrating example traces of IR reflection according to the curvature of a floor surface where a projector is positioned according to various embodiments;

FIG. 11 is a perspective view illustrating an example of generating an IR irradiation area by adjusting an IR irradiation angle according to various embodiments;

FIG. 12 is a block diagram illustrating an example configuration of a projector according to various embodiments;

FIG. 13 is a diagram illustrating an example projection screen area and an IR irradiation area according to various embodiments;

FIG. 14 is a diagram illustrating an example of dividing the IR irradiation area illustrated in FIG. 13 into a number of zones according to various embodiments;

FIG. 15 is a perspective view illustrating an example 6-axis actuator rotating an IR laser module according to various embodiments;

FIG. 16 is a diagram illustrating an example of generating an IR irradiation area by adjusting an IR irradiation angle according to various embodiments; and

FIG. 17 is a flowchart illustrating an example method of operation in a projector according to various embodiments.

### DETAILED DESCRIPTION

Hereinafter, various example embodiments of the disclosure are described in greater detail with reference to the drawings. However, the disclosure may be implemented in other various forms and is not limited to the various embodiments set forth herein. The same or similar reference denotations may be used to refer to the same or similar elements throughout the disclosure and the drawings. Further, for clarity and brevity, no description may be made of well-known functions and configurations in the drawings and relevant descriptions.

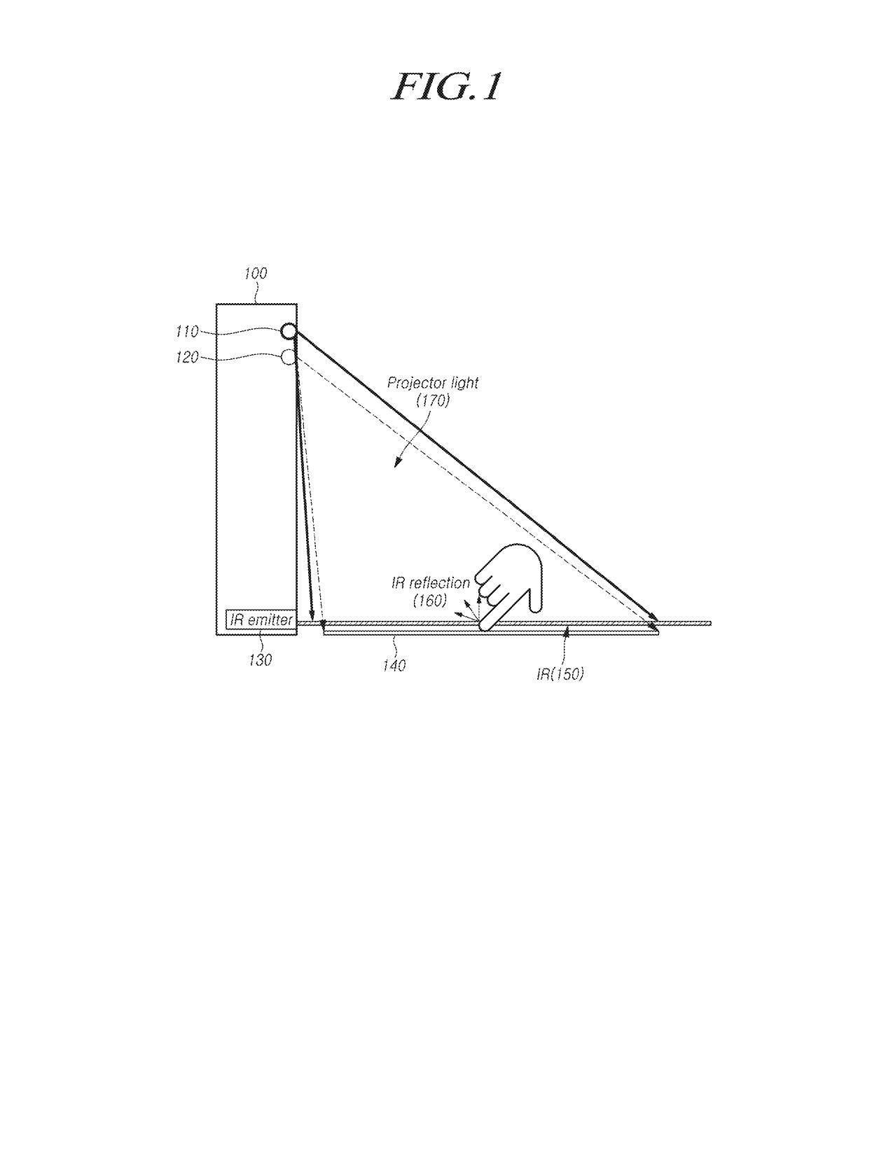

FIG. 1 is a diagram illustrating an example projector projecting an image and irradiating IR toward a floor surface according to various embodiments\.

According to various embodiments, a projector 100 may be a UST projector that may be used by placing it close to a screen or wall serving as a projection plane. A UST projector may project a large image even in a small space because it may reduce the distance between the projector and the screen serving as the projection plane. A UST projector may be mainly used in medium-sized spaces such as home theaters, conference rooms, or the like. However, it will be understood by those skilled in the art that the projector 100 of the disclosure is not necessarily limited to a UST projector and may include various types of projectors.

According to various embodiments, the projector 100 may be a projector embedded in various electronic devices or a portion of an electronic device capable of performing the function of a projector. For example, and without limitation, the projector 100 may be a projector embedded in various electronic devices such as a tablet PC, a digital camera, a camcorder, a laptop computer, a netbook computer, a tablet PC, a desktop, an e-book reader, a video phone, a digital broadcasting terminal, personal digital assistants (PDA), a portable multimedia player (PMP), a navigation device, a wearable device, a smart refrigerator, other home appliances, a portion of an electronic device capable of performing the function of a projector, etc.

According to various embodiments, the projector 100 may be fixed or mobile.

According to various embodiments, the projection plane may refer, for example, to a wall, floor, or screen on which the projector 100 projects an image. For example, the projection plane may be formed on a table on which the projector 100 is disposed. The projection plane may be a surface on which an image is clearly visible and light is strongly reflected.

According to various embodiments, the projection direction may refer, for example, to a direction in which the projector 100 projects an image. Referring to FIG. 1, the projector 100 may project an image toward a floor (e.g., a table floor) on which the projector is disposed using a projection unit 120. Referring to FIG. 1, the projection direction of the projector 100 may be a direction toward the floor on which the projector 100 is disposed. The projector 100 may project projection light 170 toward the floor on which the projector 100 is disposed using the projection unit 120. Referring to FIG. 1, the projector 100 may generate a projection screen area 140 by projecting an image onto the table floor surface (e.g., the projection plane) on which the projector is disposed. The projector 100 may determine the size and position of the generated projection screen area 140 using at least one sensor 110.

According to various embodiments, the projector 100 may generate an IR irradiation area by irradiating IR 150 in a horizontal direction on the projection plane. The IR irradiation area may be an area obtained by extending the projection screen area by a predetermined margin length. For example, the IR irradiation area may be an area obtained by extending the projection screen area by +5% length. Further, the projector 100 may generate the IR irradiation area by irradiating IR 150 at a predetermined distance in a vertical direction from the projection plane. For example, the projector 100 may irradiate IR 150 at a distance of 3mm to 7mm in a vertical direction from the projection plane, but the disclosure is not limited thereto. The projector 100 may irradiate IR 150 with a beam width of 1mm to 2mm, but the disclosure is not limited thereto. The projector 100 may set an area corresponding to a projection screen area of the IR irradiation area as a user touch area in case that IR reflection is not detected in the IR irradiation area in an environment where there is no external obstacle such as a user's body portion between the projection unit 120 and the projection plane.

According to various embodiments, the projector 100 may detect a user's touch input on the projection screen area 140 using at least one sensor 110. A touch input may be made using the user's body portion or various input means. Based on there being a user touch input in the set user touch area, the projector 100 may detect the user touch by detecting IR reflection 160 at the user touch point using at least one sensor 110. The projector 100 may detect IR reflection by detecting a luminance component equal to or greater than a predetermined threshold from an image sensing the IR irradiation area by at least one sensor 110. For example, the predetermined threshold may be set to a luminance component of 50 or more, but it is understood by those skilled in the art that it is not limited thereto. The projector 100 may convert the user touch point into coordinates of the projection screen area based on the detected IR reflection to recognize it as the user touch input. The projector 100 may perform an interaction corresponding to the recognized user touch input.

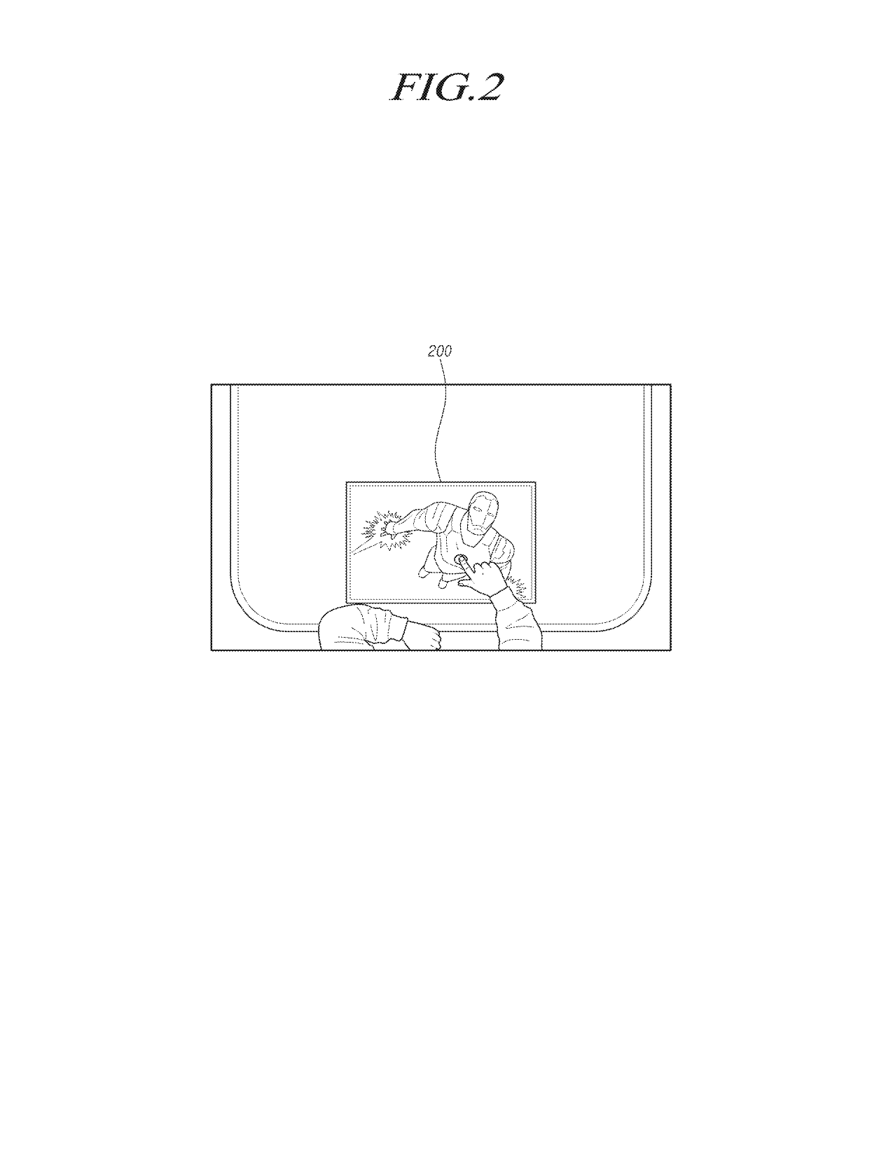

FIG. 2 is a diagram illustrating an example of use of a projector according to various embodiments.

Referring to FIG. 2, the projector 100 may generate a projection screen area 200 on the projection plane which is the table floor surface by projecting an image toward the table floor. The projector 100 may generate an IR irradiation area by irradiating IR 150 in a horizontal direction at a predetermined length (e.g., 3mm to 7mm) apart in a vertical direction from the projection plane. The IR irradiation area may be an area obtained by extending the projection screen area by a predetermined length (e.g., +5%). The IR may be irradiated with a predetermined beam width (e.g., 1mm to 2mm). The projector 100 may set an area corresponding to the projection screen area 200 of the IR irradiation area as the user touch area based on IR reflection being not detected in the IR irradiation area in a predetermined operation mode. The predetermined operation mode may be an operation mode for the projector 100 to detect IR reflection by an object other than the user touch in the IR irradiation area. The predetermined operation mode may be automatically entered after powering on the projector 100 or manually entered by a user input to set the user touch area, but the disclosure is not limited thereto. The projector 100 may detect the user touch through IR reflection detection in the set user touch area. The projector 100 may convert the user touch point into coordinates of the projection screen area 200 based on the detected IR reflection to recognize it as the user touch input. The projector 100 may perform an interaction corresponding to the recognized user touch input.

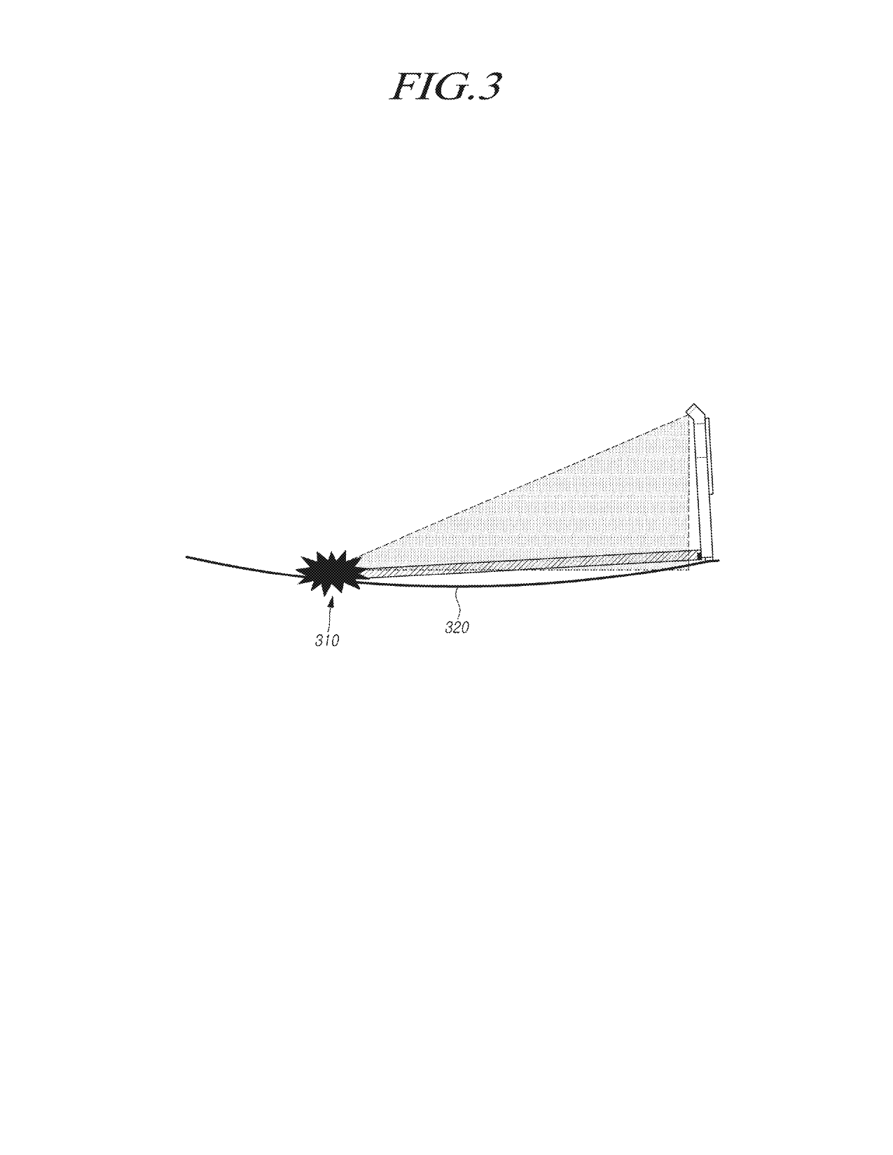

FIG. 3 is a diagram illustrating an example in which an IR irradiation surface is not normally generated according to various embodiments.

Referring to FIG. 3, the projector 100 may be positioned on a curved table 320 to generate a projection screen area on the projection plane which is the table floor surface. The projector 100 may irradiate IR in a horizontal direction at a predetermined length apart in a vertical direction from the projection plane. In this case, the projector 100 may detect IR reflection at a point 310 where the IR touches the table floor due to the curvature of the table despite the absence of an external obstacle such as the user touch. In case that the point 310 where the IR touches the table floor is within the projection screen area, it may be incorrectly recognized as the user touch despite the absence of the user touch, or even in case that there is the user touch behind the point 310 where the IR touches the table floor, the user touch point cannot be normally detected because a luminance component equal to or greater than a predetermined threshold cannot be detected at the user touch point.

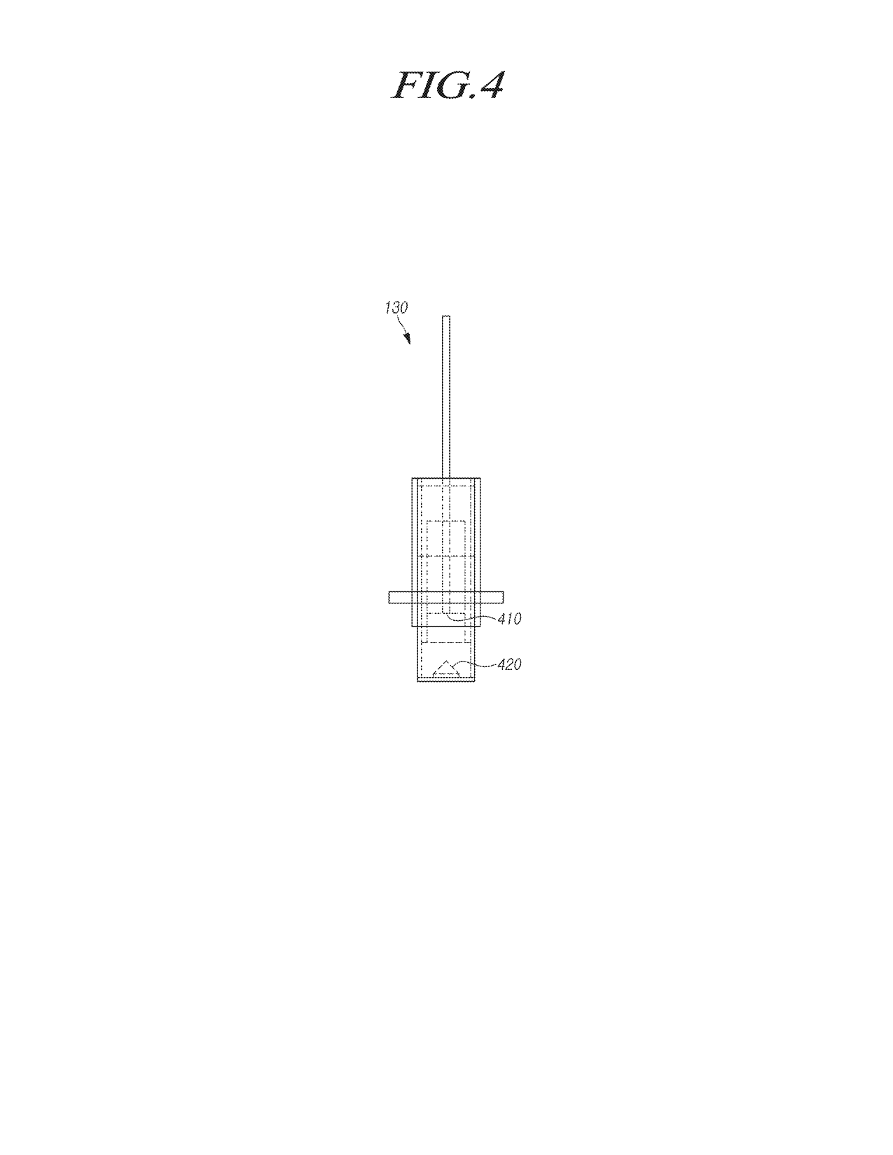

FIG. 4 is a diagram illustrating an example IR emitter irradiating IR according to various embodiments.

According to an embodiment, an IR emitter 130 may generate a user touch area by generating an IR irradiation area in a horizontal direction on the projection plane. The IR emitter 130 may be positioned at the lower portion of the projector 100, but the disclosure is not limited thereto. The IR emitter 130 may include various circuitry including, for example, an IR laser module 410 and an IR reflection module 420. The IR laser module 410 may include various circuitry and irradiate IR in a vertical direction. The IR laser module 410 may be configured in a straw-like shape, but the disclosure is not limited thereto. The IR reflection module 420 may include various a reflective material and reflect the IR irradiated in the vertical direction by the IR laser module 410 to the projection plane in a horizontal direction. The IR reflection module 420 may be configured in a cone shape, but the disclosure is not limited thereto.

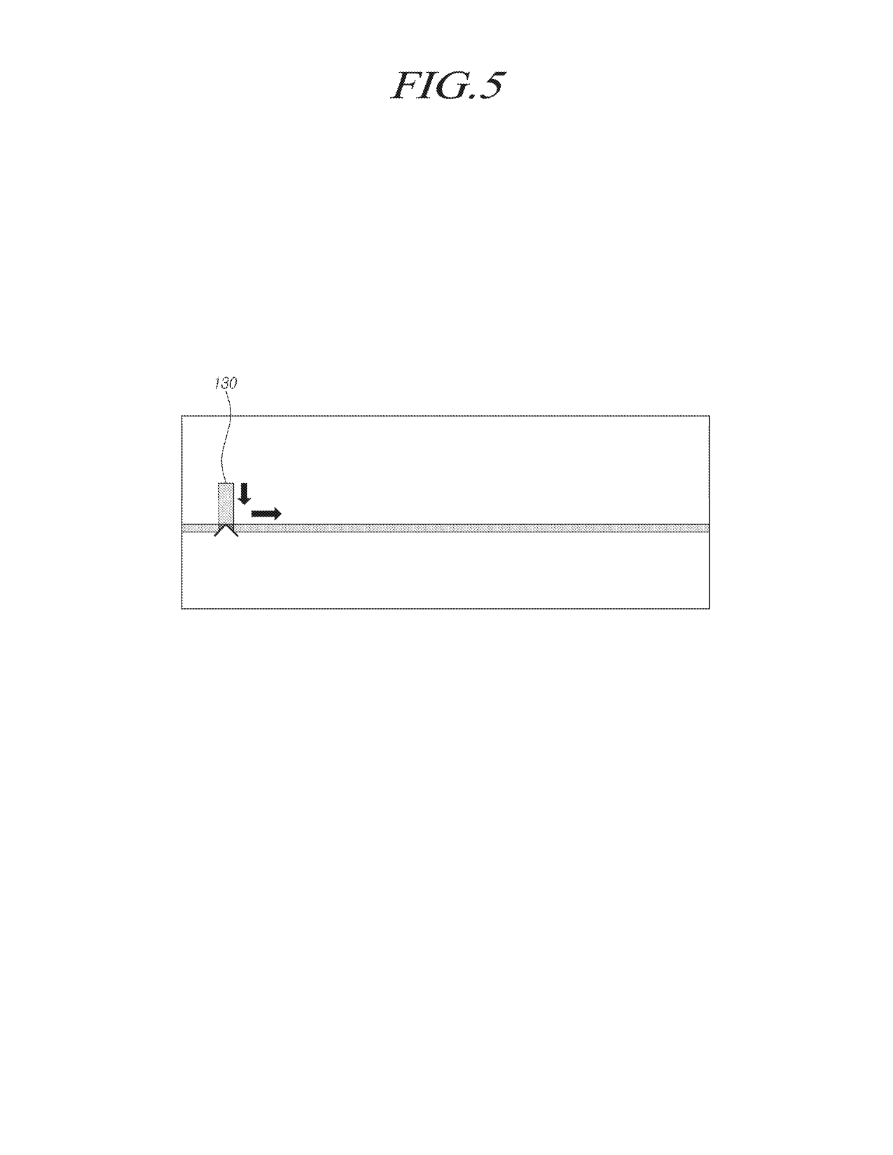

FIG. 5 is a diagram illustrating an example in which an IR emitter generates an IR irradiation area on a floor surface without curvature according to various embodiments.

Referring to FIG. 5, in an environment where a table is not curved, the IR emitter 130 may generate an IR irradiation area in a horizontal direction on the projection plane. The IR reflection module 420 may reflect the IR in a horizontal direction, e.g., a direction perpendicular to the projection plane, by reflecting the IR irradiated in the vertical direction by the IR laser module 410 on a conical surface.

As in FIG. 5, in an environment where the table is not curved, the IR reflected in a horizontal direction on the projection plane by the IR reflection module 420 may not touch the table floor. Therefore, in case that there is no external obstacle such as the user's body portion between the projection unit 120 and the projection plane, IR reflection is not detected in the IR irradiation area.

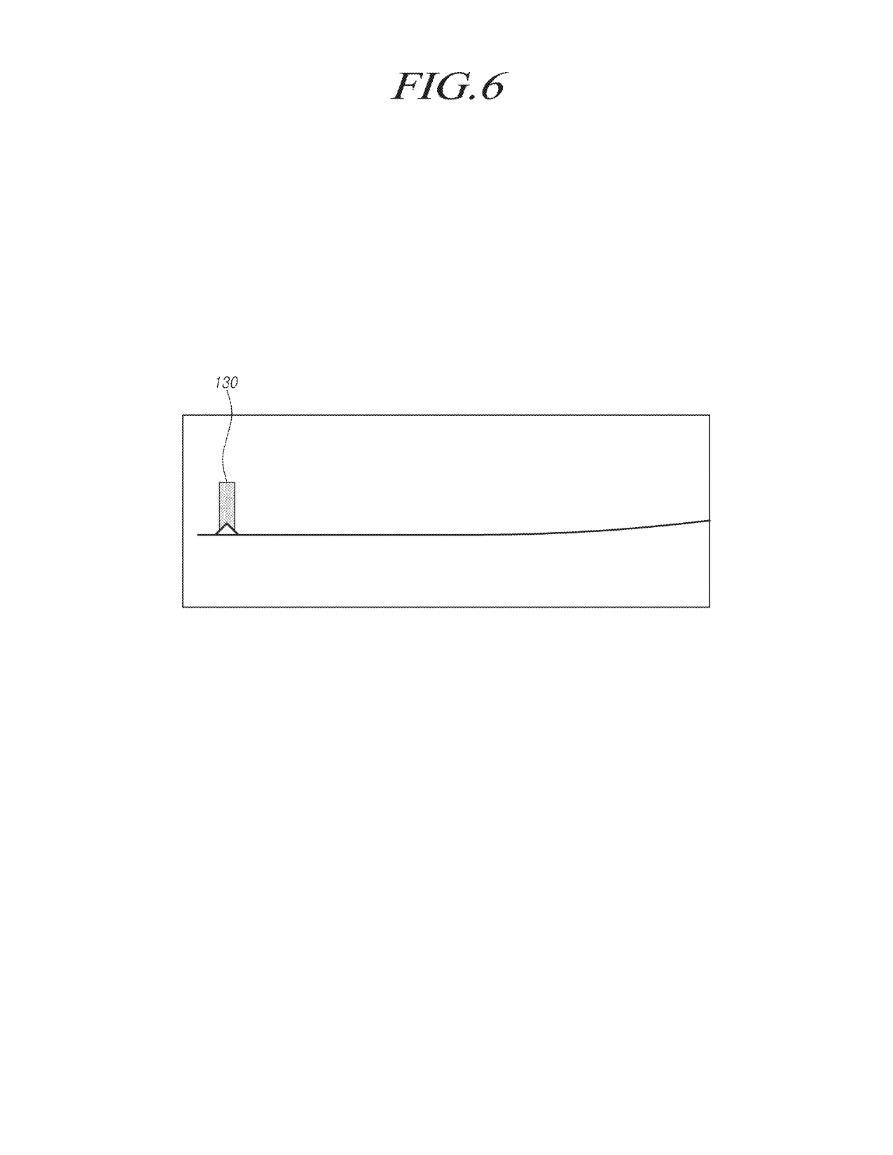

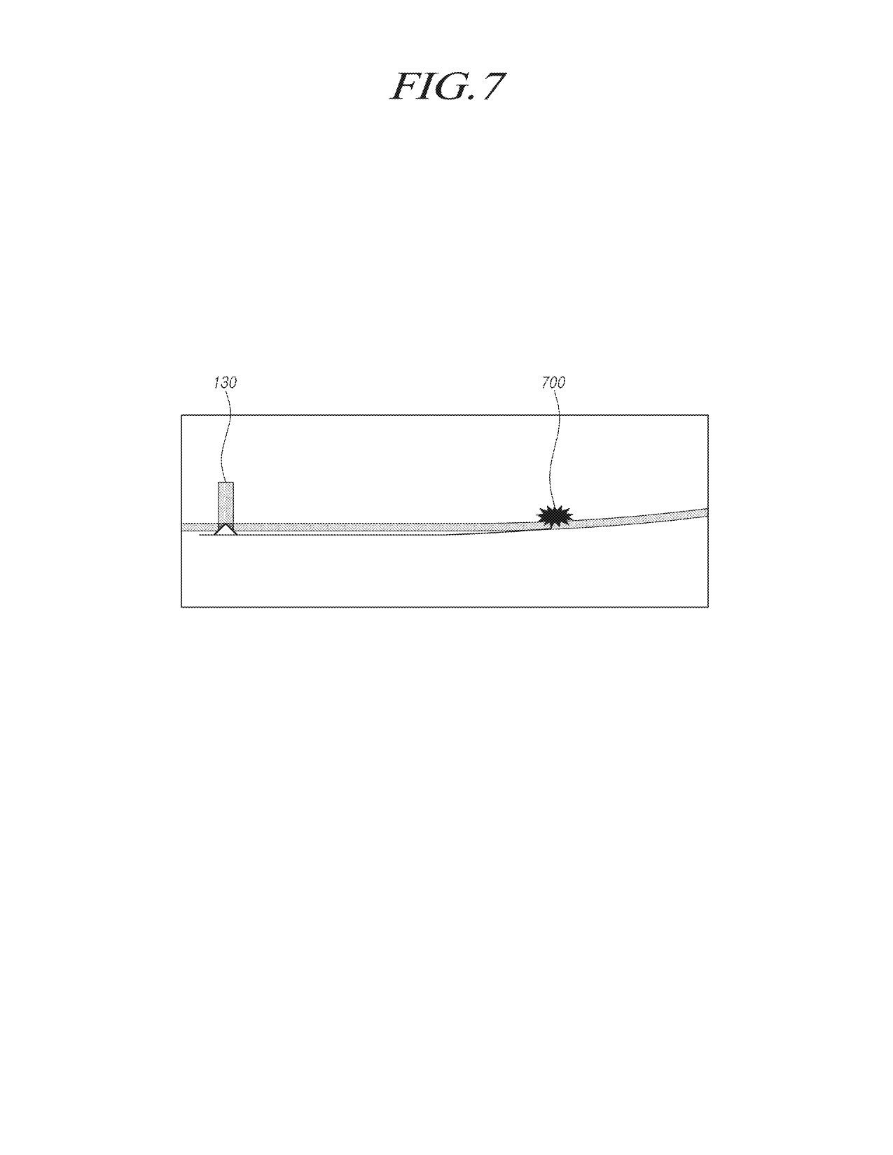

FIG. 6 is a diagram illustrating an example of a floor surface with curvature according to various embodiments. FIG. 7 is a diagram illustrating an example in which an IR emitter generates an IR irradiation area on the floor surface with curvature illustrated in FIG. 6 according to various embodiments.

As in FIG. 6, in an environment where the table on which the projector 100 is disposed is curved, the IR emitter 130 may generate an IR irradiation area in a horizontal direction on the projection plane. In an environment where the table is curved, the IR reflected in a horizontal direction on the projection plane by the IR reflection module 420 may touch the floor at a specific position 700 of the table due to the influence of the curvature of the table. Therefore, IR reflection may be detected at the point 700 where the IR touches the table floor due to the curvature of the table, despite the absence of an external obstacle such as the user's body portion between the projection unit 120 and the projection plane.

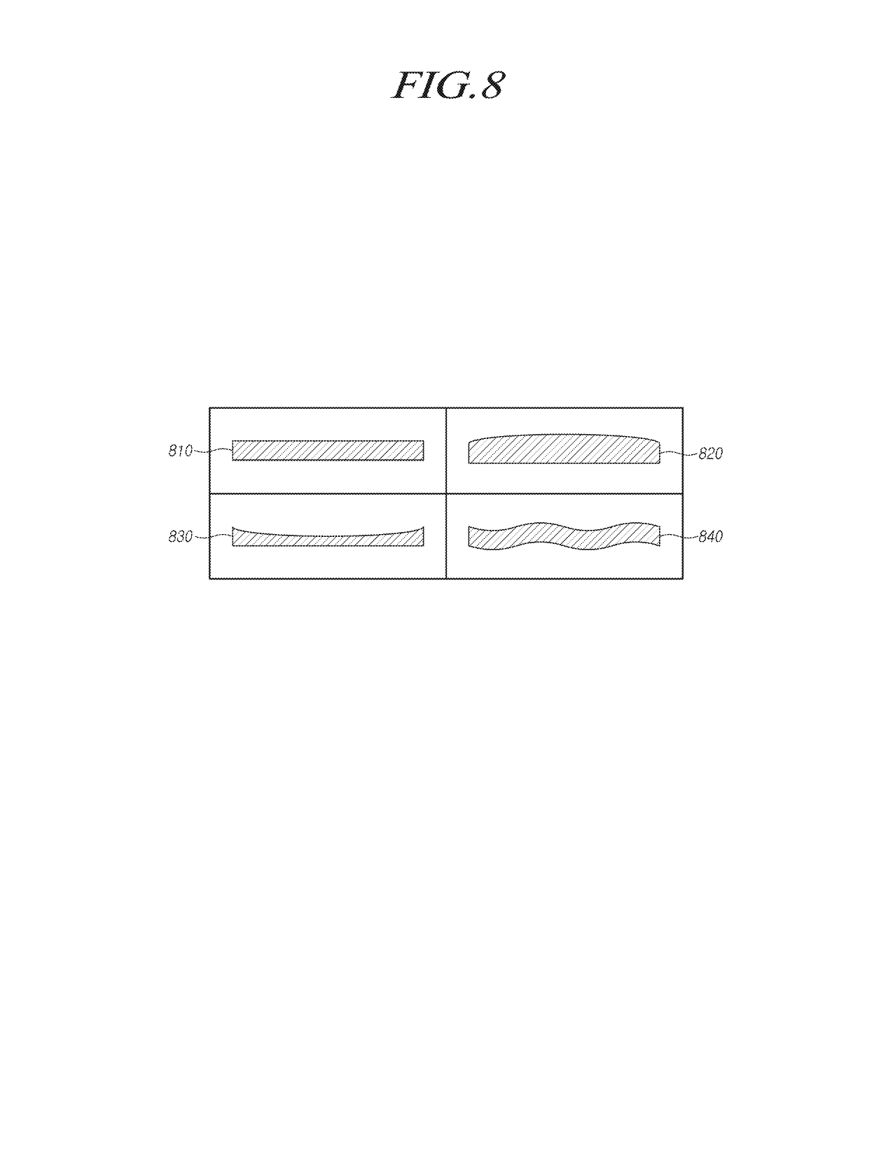

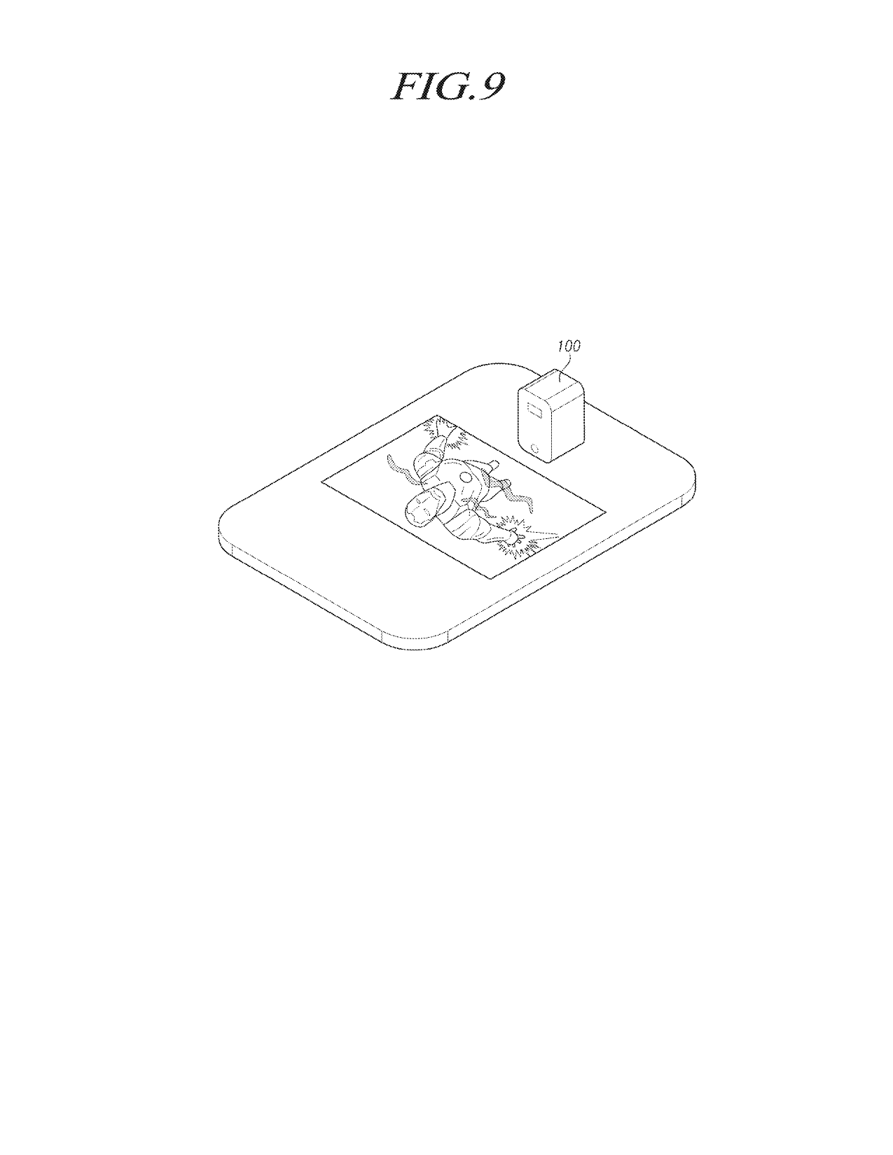

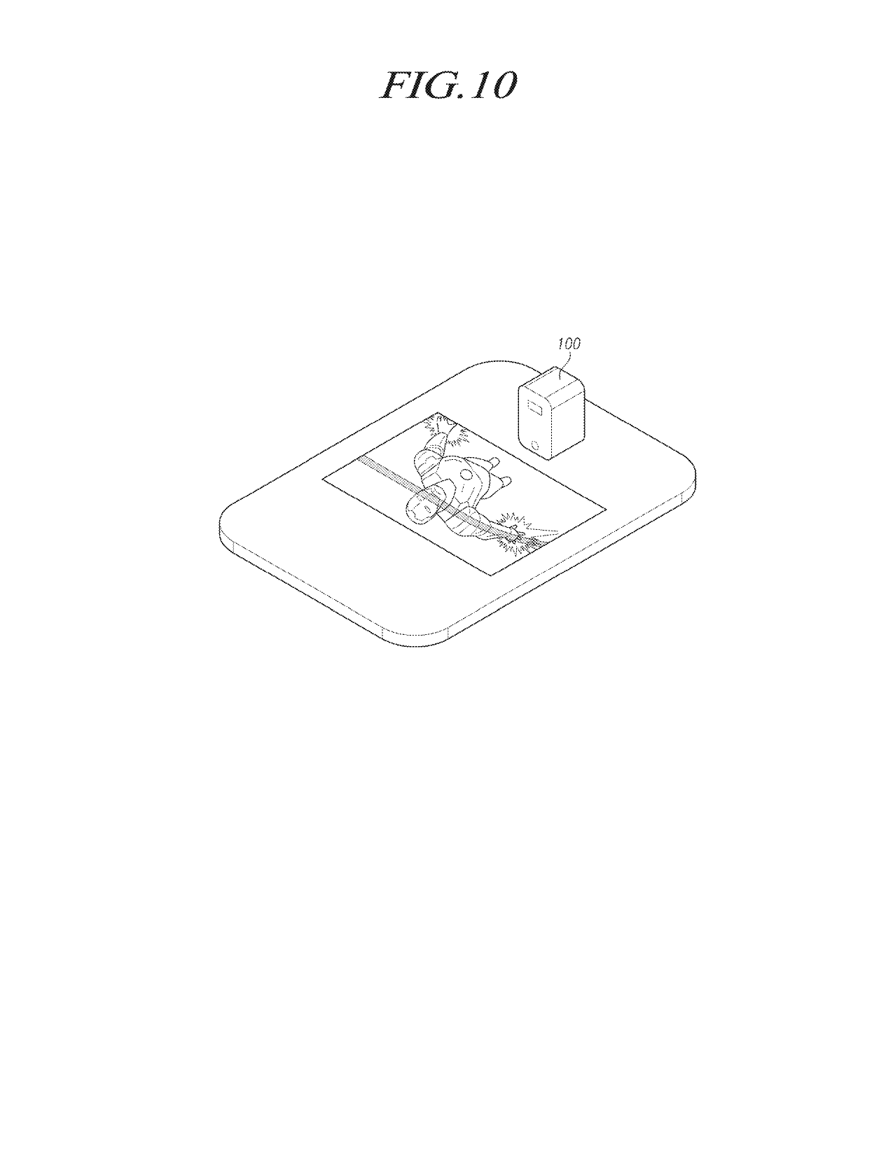

FIG. 8 is a diagram illustrating various example floor surfaces where a projector is positioned according to various embodiments. FIGS. 9 and 10 are perspective views illustrating example traces of IR reflection according to the curvature of a floor surface where a projector is positioned according to various embodiments.

Referring to FIG. 8, the shape of a table on which the projector 100 may be positioned may include a horizontal table 810, an upwardly convex table 820, a downwardly concave table 830, and a wavy table 840, but the disclosure is not limited thereto.

For example, in case that the projector 100 is positioned on the wavy table 840, the IR irradiated by the IR emitter 130 of the projector 100 may touch several floor points of the table as in FIG. 9 due to the influence of the undulations of the table floor surface. FIG. 9 illustrates traces of IR reflection in a zigzag shape according to the undulations of the table floor surface.

As another example, in case that the projector 100 is positioned on the downwardly concave table 830, the IR irradiated by the IR emitter 130 of the projector 100 may touch several floor points of the table as in FIG. 10 based on the overall curved shape of the table. FIG. 10 illustrates traces of IR reflection in a line shape according to the curvature of the table floor surface.

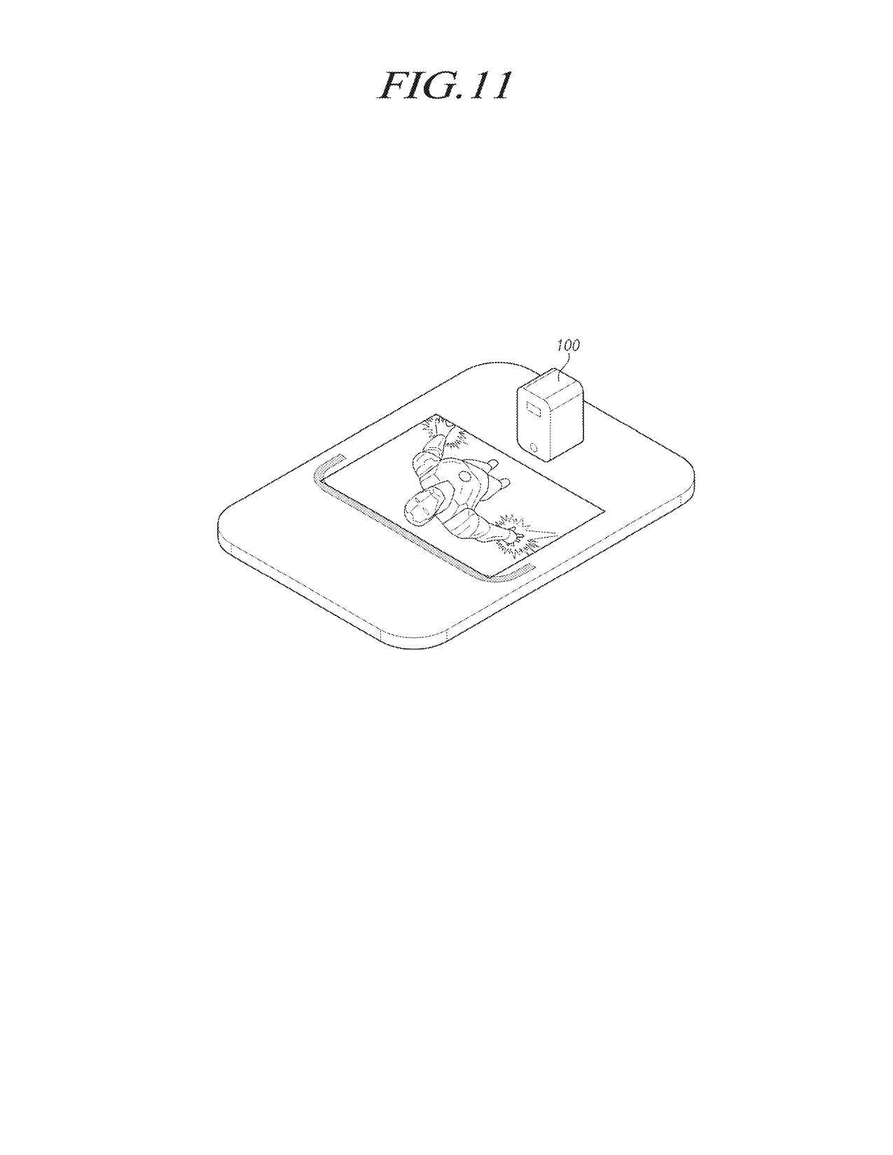

FIG. 11 is a perspective view illustrating an example of generating an IR irradiation area by adjusting an IR irradiation angle according to various embodiments.

According to an embodiment, the projector 100 may determine whether it is affected by the curvature of the floor surface on which the projector 100 is positioned (or the curvature of the table) by determining whether IR reflection is detected in the IR irradiation area in a predetermined operation mode. The predetermined operation mode may be an operation mode for the projector 100 to detect IR reflection by an object other than the user touch in the IR irradiation area. The predetermined operation mode may be automatically entered after powering on the projector 100 or manually entered by a user input to set the user touch area, but the disclosure is not limited thereto.

According to an embodiment, based on IR reflection being detected in the predetermined operation mode, the projector 100 may adjust an IR irradiation angle so that IR reflection is not detected in the IR irradiation area. In other words, the projector 100 may detect whether the irradiated IR is affected by the curvature of the table, and calibrate the user touch area by setting an IR irradiation angle optimized for the table shape so as not to be affected by the table curvature.

According to an embodiment, based on IR reflection being detected in the predetermined operation mode, the projector 100 may adjust a height of the IR emitter 130 so that IR reflection is not detected in the IR irradiation area. In other words, the projector 100 may detect whether the irradiated IR is affected by the curvature of the table, and calibrate the user touch area by adjusting the height of the IR emitter 130 to increase the distance between the projection plane and the IR irradiation area so as not to be affected by the table curvature.

Therefore, according to an embodiment, the limitation of having to reduce the user touch area and the screen projection area because the user touch area is not normally generated due to the curvature of the projection floor surface may be overcome.

FIG. 11 illustrates an example in which the projector 100 adjusts an IR irradiation angle so that IR reflection is not detected in the IR irradiation area in the curved table floor surface environment illustrated in FIG. 10. In the illustrated example, the IR irradiation area may be an area obtained by extending the projection screen area by a predetermined length (e.g., +5%). The projector 100 may ensure that IR reflection is not detected in the IR irradiation area in an environment where there is no external obstacle such as the user's body portion between the projection unit 120 and the projection plane through IR irradiation angle adjustment, and may set an area corresponding to the projection screen area of the IR irradiation area where IR reflection is not detected as the user touch area.

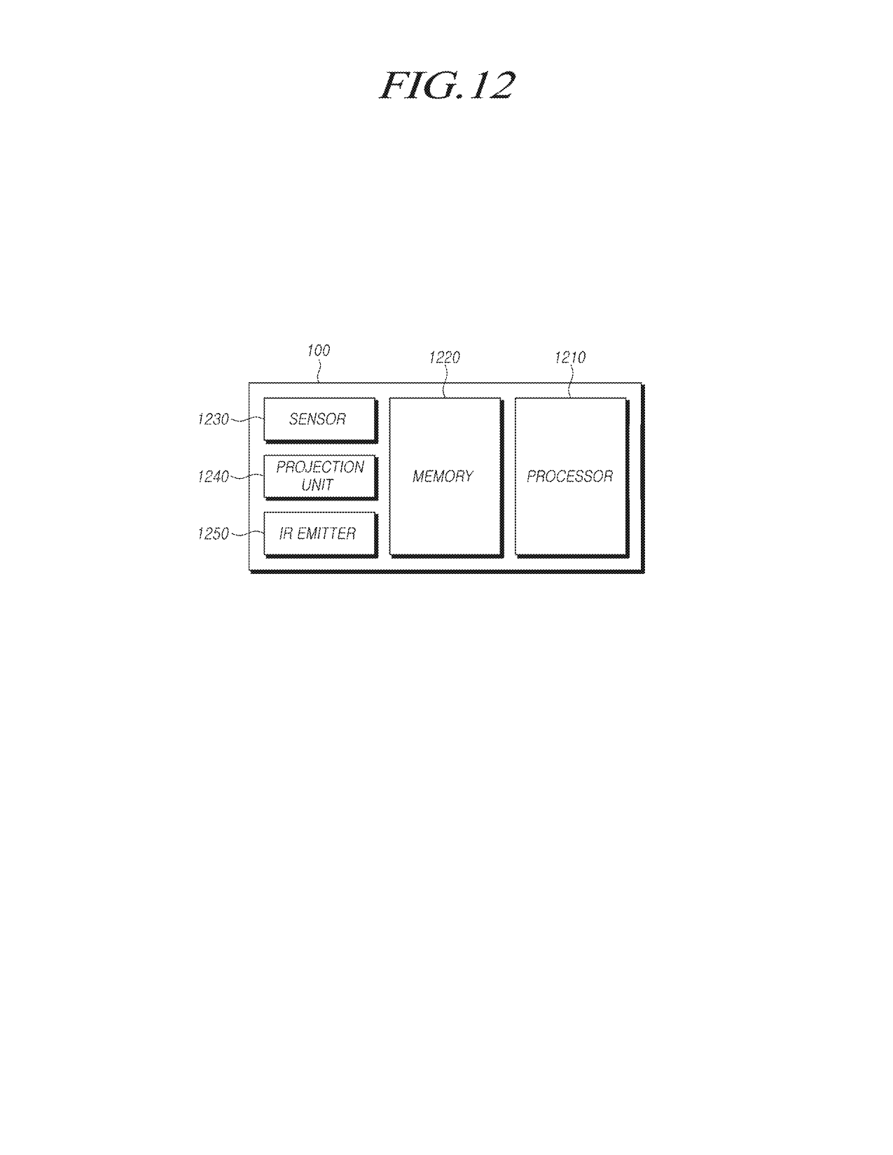

FIG. 12 is a block diagram illustrating an example configuration of a projector according to various embodiments.

Referring to FIG. 12, the projector 100 may include a processor (e.g., including processing circuitry) 1210, a memory 1220, a sensor 1230, a projection unit (e.g., including circuitry) 1240, and an IR emitter (e.g., including circuitry) 1250. The projector 100 may further include at least one of an input/output interface (not illustrated), a speaker (not illustrated), a driving unit (not illustrated), and a power supply (not illustrated). The projector 100 may include additional components other than the illustrated components or may omit at least one of the illustrated components.

The projector 100 may refer, for example, to an electronic device that projects an image. For example, the projector 100 may be an optical device that projects an image onto a projection plane. The projection plane may be formed on a table, screen, or wall on which the projector 100 is disposed, but the disclosure is not limited thereto.

The processor 1210 may include various processing circuitry and perform overall control operations of the projector 100. The processor 1210 may be embedded and included inside the projector 100, or may be connected to and included in the projector 100 using an input/output interface.

The processor 1210 may be implemented as a digital signal processor (DSP) that processes digital signals, a microprocessor, or a time controller (TCON). However, without limitations thereto, the controller 720 may include one or more of a central processing unit (CPU), a micro controller unit (MCU), a micro processing unit (MPU), a controller, an application processor (AP), a graphics processing unit (GPU), a communication processor (CP), or an ARM processor, or may be defined by corresponding terms. The processor 1210 may be implemented as a system on chip (SoC) or large scale integration (LSI) with a built-in processing algorithm, or may be implemented in the form of a field programmable gate array (FPGA). Further, the processor 1210 may perform various functions by executing computer executable instructions stored in the memory 1220. Thus, the processor 1210 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited /disclosed functions, e.g., in a distributed manner. At least one processor may execute program instructions to achieve or perform various functions.

The memory 1220 may be implemented as an internal memory such as read-only memory (ROM) (e.g., electrically erasable programmable read-only memory (EEPROM)) or random access memory (RAM) included in the processor 1210, or may be implemented as a memory separate from the processor 1210. In this case, the memory 1220 may be implemented in the form of a memory embedded in the projector 100 or in the form of a memory detachable from the projector 100 according to data storage purposes. For example, data for driving the projector 100 may be stored in a memory embedded in the projector 100, and data for extended functions of the projector 100 may be stored in a memory detachable from the projector 100.

In the case of a memory embedded in the projector 100, it may be implemented as at least one of volatile memory (e.g., dynamic RAM (DRAM), static RAM(SRAM), or synchronous dynamic RAM (SDRAM)), non-volatile memory (e.g., one time programmable ROM (OTPROM), programmable ROM (PROM), erasable and programmable ROM (EPROM), electrically erasable and programmable ROM (EEPROM), mask ROM, flash ROM, flash memory (e.g., NAND flash or NOR flash), a hard drive, or a solid state drive (SSD)). In the case of a memory detachable from the projector 100, it may be implemented in the form of a memory card (e.g., compact flash (CF), secure digital (SD), micro secure digital (Micro-SD), mini secure digital (Mini-SD), extreme digital (xD), multi-media card (MMC)), an external memory connectable to a USB port (e.g., USB memory), or the like.

The projection unit 1240 may include various circuitry, a light source lamp (not illustrated) and a lens (not illustrated). The light source lamp may refer, for example, to an element that outputs light. Light output from the light source lamp may be projected onto the projection plane through the lens. The projection unit 1240 may generate a projection screen area on the projection plane, and may project an input image input by the input/output interface onto the projection screen area. The projection unit 1240 may project by enlarging or reducing the input image on the projection plane.

The IR emitter 1250 may include various circuitry and generate a user touch area by generating an IR irradiation area in a horizontal direction on the projection plane. The IR emitter 1250 may generate the IR irradiation area by extending the projection screen area by a predetermined margin length. For example, theIR emitter 1250 may generate the IR irradiation area by extending the projection screen area by +5% length. The IR emitter 1250 may generate an IR irradiation area by irradiating IR150 at a predetermined length apart in a vertical direction from the projection plane. For example, the projector 100 may irradiate IR 150 at a distance of 3mm to 7mm in a vertical direction from the projection plane, but the disclosure is not limited thereto. The IR emitter 1250 may irradiate IR with a beam width of 1mm to 2mm, but the disclosure is not limited thereto.

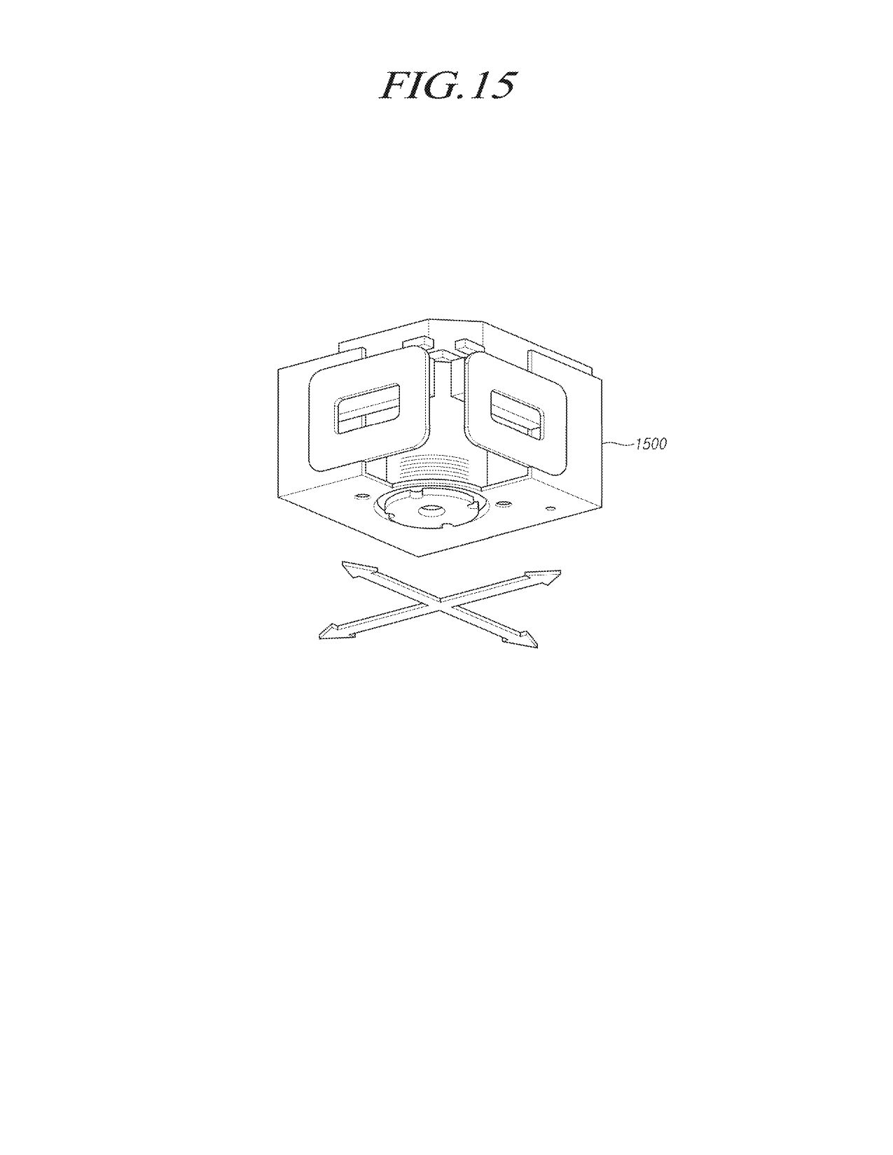

The IR emitter 1250 may include an IR laser module and an IR reflection module. The IR laser module may irradiate IRin a vertical direction. The IR laser module may be configured in a straw-like shape, but the disclosure is not limited thereto. The IR reflection module may include a reflective material and reflect the IR irradiated in the vertical direction by the IR laser module to the projection plane in a horizontal direction. The IR reflection module may be configured in a cone shape, but the disclosure is not limited thereto. The IR emitter 1250 may further include a 6-axis actuator rotating the IR laser module about at least one axis including an X-axis and a Y-axis. The 6-axis actuator is described below with reference to FIG. 15.

The sensor 1230 may include at least one of various types of sensors. The sensor 1230 may include at least one of a camera, an infrared sensor (IR sensor), an RGB sensor, an acceleration sensor, a touch sensor, a proximity sensor, a distance sensor, an illumination sensor, a tilt sensor, a magnetic sensor, a gravity sensor (G-sensor), a gyroscope sensor, a motion sensor, a finger scan sensor, an ultrasonic sensor, an optical sensor, an air pressure sensor, a humidity sensor, a temperature sensor, a radiation detection sensor, a heat detection sensor, a gas detection sensor, an electronic nose, a healthcare sensor, or a biometric sensor, but the disclosure is not limited thereto.

The sensor 1230 may include a lens and an image sensor. The lens may include a general-purpose lens, a wide-angle lens, and a zoom lens, but the disclosure is not limited thereto. The lens may be determined according to the type, characteristics, usage environment, etc. of the projector 100. The image sensor may include a complementary metal oxide semiconductor (CMOS) and a charge coupled device (CCD), but the disclosure is not limited thereto. The sensor 1230 may output incident light as an image signal. Specifically, the sensor 1230 may include a lens, a pixel, and an AD converter. The lens collects light from a subject to form an optical image in a capturing area, and the pixel may output light incident through the lens as an analog-type image signal. The ADconverter may convert an analog-type image signal into a digital-type image signal and output it. The sensor 1230 may be disposed to photograph or sense the projection screen area or the IR irradiation area of the projector 100.

According to an embodiment, the sensor 1230 may detect an operation state (e.g., power or temperature), movement, projection screen area, IR irradiation area, and external environmental state (e.g., user state) of the projector 100, and may generate an electrical signal or data value corresponding to the detected state.

According to an embodiment, the sensor 1230 may image-sense the projection screen area projected by the projection unit 1240. For example, an RGB sensor may image sense the projection screen area projected by the projection unit 1240. The processor 1210 may determine the size and position of the projection screen area based on an image sensing the projection screen area by the sensor 1230.

According to an embodiment, the sensor 1230 may image sense the IR irradiation area irradiated by the IR emitter 1250. For example, an IR sensor may image sense the IR irradiation area irradiated by the IR emitter 1250. The processor 1210 may determine whether IR reflection is detected in the IR irradiation area based on an image sensing the IR irradiation area by the sensor 1230. The processor 1210 may detect IR reflection by detecting a luminance component equal to or greater than a predetermined threshold from an image sensing the IR irradiation area by the sensor 1230. For example, the predetermined threshold may be set to a luminance component of 50 or more, but it is understood by those skilled in the art that it is not limited thereto.

According to an embodiment, the sensor 1230 may detect movement or direction of the projector 100. For example, an acceleration sensor may detect movement of the projector 100. The processor 1210 may control to adjust an IR irradiation angle or adjust a height of the IR emitter 1250 in response to detecting movement of the projector 100 by the sensor 1230 or powering on the projector.

The input/output interface (not illustrated) may include various wired and wireless interfaces including various circuitry capable of inputting and outputting images, image information, and audio from or to an external device under the control of the processor 1210. The input/output interface may include at least one of a wired communication interface, a wireless interface, and a short-range communication interface. It will be understood by those skilled in the art that the input/output interface may be added, deleted, and/or changed according to the performance and structure of the projector 100. The wired communication interface may include at least one interface of high definition multimedia interface (HDMI), mobile high-definition link (MHL), universal serial bus (USB), display port (DP), Thunderbolt, video graphics array (VGA) port, RGB port, D-subminiature (D-SUB), or digital visual interface (DVI). The wireless interface may include Wi-Fi, but the disclosure is not limited thereto. The wireless interface may support the wireless LAN standard (IEEE802.11x) of the Institute of Electrical and Electronics Engineers (IEEE). The wireless interface may be wirelessly connected to an access point (AP) under the control of the processor 1210. The short-range communication interface may wirelessly perform short-range communication with an external device under the control of the processor 1210. Short-range communication may include Bluetooth, Bluetooth low energy, infrared data association (IrDA), ultra-wide band (UWB), Wi-Fi Direct, and near field communication (NFC), but the disclosure is not limited thereto. The external device may include an image providing device (e.g., a display device) that provides images or the like.

The speaker (not illustrated) may output various audio data input through the input/output interface as well as various notification sounds or voice messages.

The driving unit (not illustrated) may include various circuitry and control the direction and angle of the projector 100 or control the movement of the main body of the projector 100.

The power supply (not illustrated) may supply power to at least one component of the projector 100. The power supply may include at least one of a rechargeable battery and a power cable capable of receiving external power. For example, in case that the power supply includes both a battery and a power cable, power may be supplied by plugging in the power cable where there is an outlet, and power may be supplied through the built-in battery where there is no outlet.

According to an embodiment, the processor 1210 may be electrically connected to the sensor 1230, the projection unit 1240, the IR emitter 1250, and the memory 1220.

According to an embodiment, the processor 1210 may determine a projection screen area on the projection plane. The processor 1210 may determine the size and position of the projection screen area based on an image sensing the projection screen area by the sensor 1230.

According to an embodiment, the processor 1210 may determine whether IR reflection is detected in an IR irradiation area in a predetermined operation mode. The predetermined operation mode may be an operation mode for the projector 100 to detect IR reflection by an object other than the user touch in the IR irradiation area. The predetermined operation mode may be automatically entered after powering on the projector 100 or manually entered by a user input to set the user touch area, but the disclosure is not limited thereto. The processor 1210 may detect IR reflection by detecting a luminance component equal to or greater than a predetermined threshold from an image sensing the IR irradiation area by the sensor 1230. For example, the predetermined threshold may be set to a luminance component of 50 or more, but it is understood by those skilled in the art that it is not limited thereto. In case that IR reflection is detected, the processor 1210 may control to adjust an irradiation angle of the IR emitter 1250 so that IR reflection is not detected in the IR irradiation area.

According to an embodiment, the processor 1210 may control the 6-axis actuator to rotate the IR laser module about the at least one axis including the X-axis and the Y-axis so that IR reflection is not detected in the IR irradiation area. The processor 1210 may control the 6-axis actuator to rotate the IR laser module about the Y-axis so that IR reflection is not detected in the IR irradiation area based on IR reflection being detected in a horizontal direction. The processor 1210 may control the 6-axis actuator to rotate the IR laser module about the X-axis and the Y-axis so that IR reflection is not detected in the IR irradiation area based on IR reflection being detected in a diagonal direction.

According to an embodiment, the processor 1210 may control the projector 100 to adjust a height of the IR emitter 1250 so that IR reflection is not detected in the IR irradiation area. In other words, the processor 1210 may adjust the height of the IR emitter 1250 to increase the distance between the projection plane and the IR irradiation area so that IR reflection is not detected in the IR irradiation area. The processor 1210 may gradually adjust the height of the IR emitter 1250 by a predetermined value so that touch recognition may be performed at a point as close as possible to the floor surface while IR reflection is not detected in the IR irradiation area.

According to an embodiment, the processor 1210 may control the IR reflection module to move the IR reflection module along the Y-axis so that IR reflection is not detected in the IR irradiation area. The processor 1210 may control to gradually move the IR reflection module along the Y-axis by a predetermined value so that touch recognition may be performed at a point as close as possible to the floor surface while IR reflection is not detected in the IR irradiation area.

According to an embodiment, the processor 1210 may set an area corresponding to a projection screen area of the IR irradiation area where IR reflection is not detected in the predetermined operation mode as the user touch area through at least one of the irradiation angle adjustment, the height adjustment of the IR emitter 1250, and the Y-axis movement of the IR reflection module. The processor 1210 may detect the user touch through IR reflection detection in the set user touch area. The processor 1210 may convert the user touch point into coordinates of the projection screen area based on the detected IR reflection to recognize it as the user touch input. The processor 1210 may perform an interaction corresponding to the recognized user touch input.

According to an embodiment, the processor 1210 may control to adjust an IR irradiation angle or adjust a height of the IR emitter 1250 in response to an operation of powering on the projector 100 and an operation of detecting movement of the projector 100. Therefore, whenever the installation environment or position of the projector 100 is changed, an optimized IR irradiation angle that is not affected by the projector projection floor surface may be set or the height of the IR emitter 1250 may be adjusted.

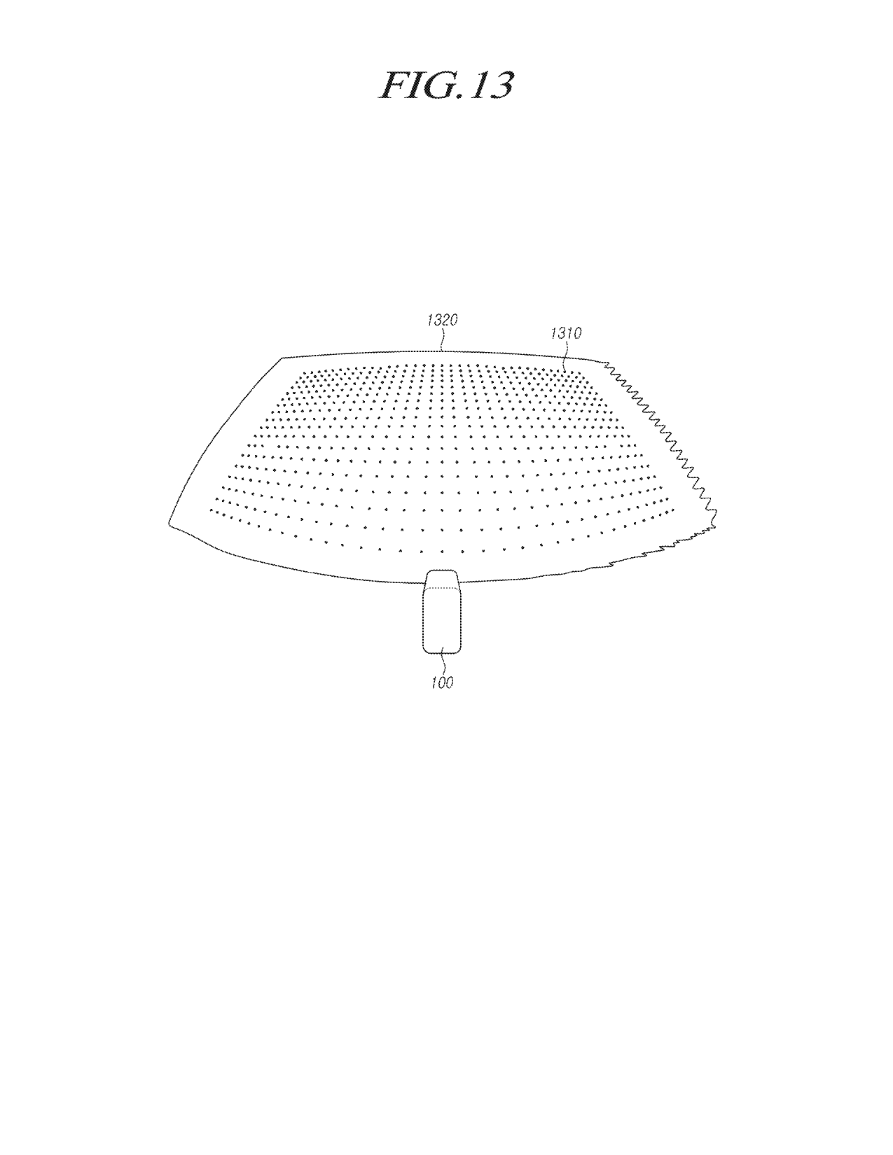

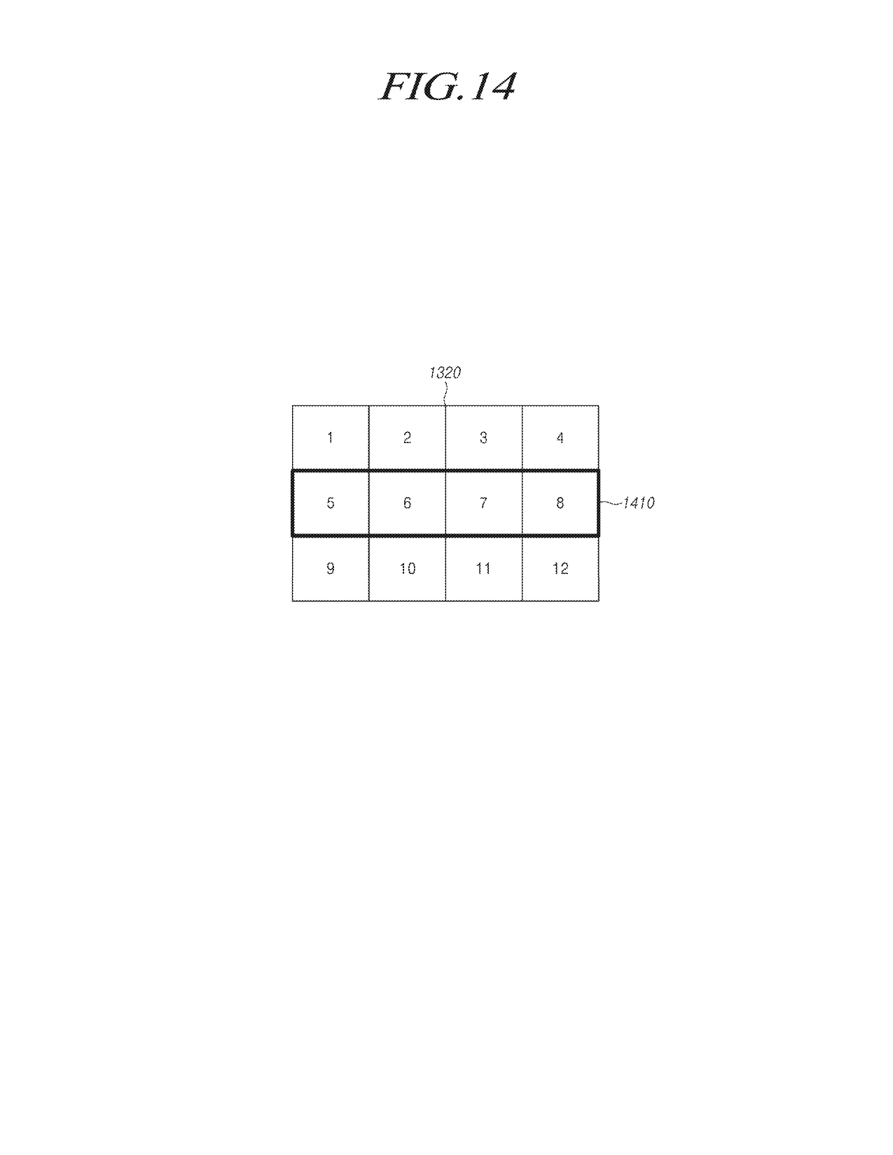

FIG. 13 is a diagram illustrating an example projection screen area and an IR irradiation area according to various embodiments. FIG. 14 is a diagram illustrating an example of dividing the IR irradiation area illustrated in FIG. 13 into a predetermined number of zones according to various embodiments. FIG. 15 is a perspective view illustrating an example 6-axis actuator rotating an IR laser module according to various embodiments.

As described above, the projector 100 may generate a projection screen area 1310 by projecting an image onto the table floor surface (e.g., the projection plane) on which the projector is disposed. The projector 100 may determine the size and position of the generated projection screen area 1310 using at least one sensor 110. The projector 100 may generate an IR irradiation area 1320 by irradiating IR in a horizontal direction on the projection plane. The IR irradiation area may be an area obtained by extending the projection screen area by a predetermined margin length. For example, the IR irradiation area may be an area obtained by extending the projection screen area by +5% length. Further, the projector 100 may generate an IR irradiation area by irradiating IR at a predetermined length apart in a vertical direction from the projection plane. For example, the projector 100 may irradiate IR at a distance of 3mm to 7mm in a vertical direction from the projection plane, but the disclosure is not limited thereto. The projector 100 may irradiate IR with a beam width of 1mm to 2mm, but the disclosure is not limited thereto.

According to an embodiment, the projector 100 may divide the IR irradiation area 1320 into a predetermined number of zones to determine a zone where IR reflection is detected and a direction in which IR reflection is detected. Referring to FIG. 14, the IR irradiation area 1320 may be divided into 12 zones in the form of a 4x3 matrix.

According to an embodiment, the projector 100 may set an initial value of an irradiation angle of the IR emitter 1250 so that IR reflection is detected in at least one reference zone in an environment where there is no external obstacle and no IR reflection in the IR irradiation area 1320 (e.g., a table environment that is not curved). For example, referring to FIG. 14, the at least one reference zone may be zones 1410 corresponding to 5, 6, 7, and 8.

According to an embodiment, in case that the projector 100 is positioned on the downwardly concave table 830 illustrated in FIG. 8, IR reflection may be detected in at least one zone positioned in front of the at least one reference zone among the IR irradiation area 1320. For example, referring to FIG. 14, in case that the projector 100 is positioned on the downwardly concave table 830 illustrated in FIG. 8, IR reflection may be detected in at least one of zones 9, 10, 11, and 12 positioned in front of the at least one reference zone. In case that IR reflection is detected, the projector 100 may control the projector to adjust an irradiation angle of the IR emitter 1250 so that IR reflection is not detected in the IR irradiation area 1320. In adjusting the irradiation angle of the IR emitter 1250, the projector 100 may gradually adjust the irradiation angle by a predetermined value until IR reflection is not detected in the IR irradiation area 1320. The projector 100 may gradually adjust the IR irradiation angle so that touch recognition may be performed at a point as close as possible to the floor surface while IR reflection is not detected in the IR irradiation area 1320. Based on IR reflection being detected in a zone positioned in front of the at least one reference zone, in adjusting the irradiation angle of the IR emitter 1250, the projector 100 may more quickly adjust the irradiation angle by adjusting the irradiation angle by a value obtained by applying a predetermined weight to the predetermined value until IR reflection is not detected in the IR irradiation area 1320.

Referring to FIG. 15, based on IR reflection being detected in a horizontal direction, the projector 100 may control a 6-axis actuator 1500 to rotate an IR laser module 410 about the Y-axis so that IR reflection is not detected in the IR irradiation area 1320. The projector 100 may control the 6-axis actuator 1500 to rotate the IR laser module 410 about the +Y axis to adjust an angle so that the IR reflected by an IR reflection module 420 faces upward.

Referring to FIG. 15, based on IR reflection being detected in a diagonal direction, the 6-axis actuator 1500 may be controlled to rotate the IR laser module 410 about the X-axis and the Y-axis so that IR reflection is not detected in the IR irradiation area 1320. The projector 100 may control the 6-axis actuator 1500 to rotate the IR laser module 410 about the +Y axis and the -X axis to adjust an angle so that the IR reflected by the IR reflection module 420 faces in a diagonally upward direction.

According to an embodiment, in case that the projector 100 is positioned on the upwardly convex table 820 illustrated in FIG. 8, IR reflection may be detected in a zone positioned behind the at least one reference zone among the IR irradiation area 1320. For example, referring to FIG. 14, in case that the projector 100 is positioned on the upwardly convex table 820 illustrated in FIG. 8, IR reflection may be detected in at least one of zones 1, 2, 3, and 4 positioned behind the at least one reference zone. In case that IR reflection is detected, the projector 100 may control to adjust an irradiation angle of the IR emitter 1250 so that IR reflection is not detected in the IR irradiation area 1320. In adjusting the irradiation angle of the IR emitter 1250, the projector 100 may gradually adjust the irradiation angle by a predetermined value until IR reflection is not detected in the IR irradiation area 1320. The projector 100 may gradually adjust the IR irradiation angle so that touch recognition may be performed at a point as close as possible to the floor surface while IR reflection is not detected in the IR irradiation area 1320.

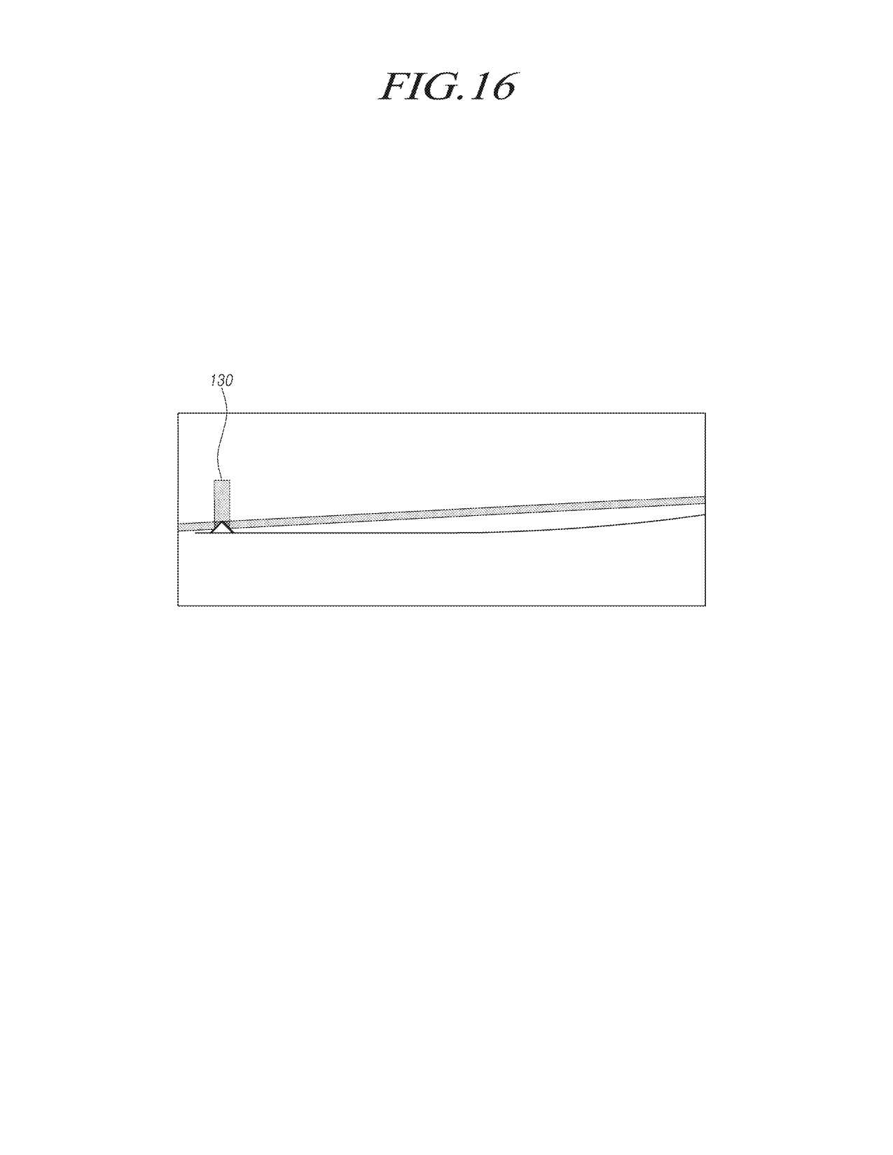

FIG. 16 is a diagram illustrating an example of generating an IR irradiation area by adjusting an irradiation angle of an IR emitter according to various embodiments.

FIG. 16 illustrates an example in which IR is irradiated by adjusting an IR irradiation angle so that IR reflection is not detected in the IR irradiation area by the projector 100 in the curved table environment illustrated in FIG. 10. Through IR irradiation angle adjustment, the projector 100 may ensure that IR reflection is not detected in the IR irradiation area in a circumstance in which there is no external obstacle despite the table being curved. The projector 100 may gradually adjust the IR irradiation angle so that touch recognition may be performed at a point as close as possible to the floor surface while IR reflection is not detected in the IR irradiation area. The projector 100 may set an area corresponding to the projection screen area of the IR irradiation area where IR reflection is not detected as the user touch area.

Referring to FIG. 16, through the IR irradiation angle adjustment, IR may not touch the table surface in the user touch area in a circumstance in which there is no external obstacle despite the table being curved. The projector 100 may detect the user touch through IR reflection detection in the set user touch area.

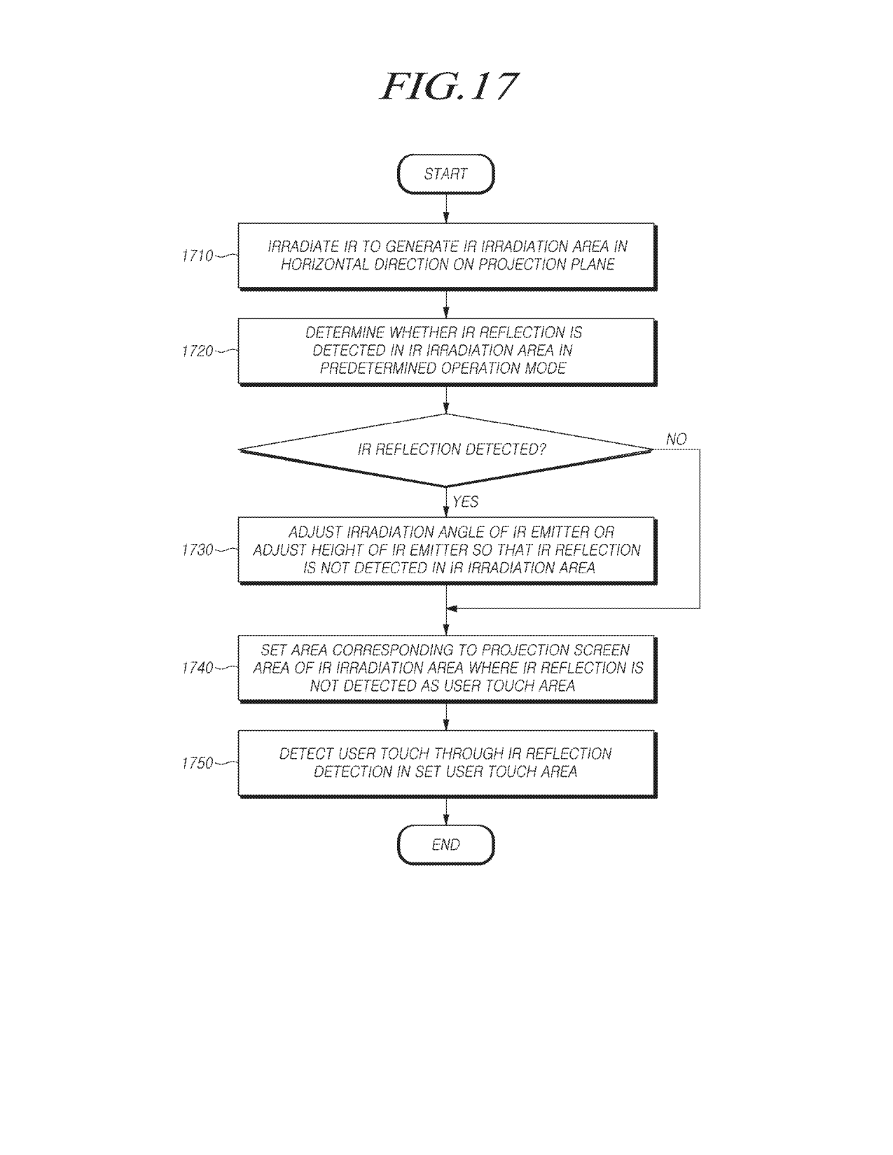

FIG. 17 is a flowchart illustrating an example method of operation in a projector according to various embodiments.

The projector of FIG. 17 may be a projector corresponding to the projector 100 of FIG. 12. In the operation of the projector described in FIG. 17, portions overlapping with those described in FIG. 12 may be omitted. Some of the operations of FIG. 17 may be omitted. Operations not shown in FIG. 17 may be added.

According to an embodiment, the projector 100 may generate a projection screen area by projecting an image onto the table floor surface (e.g., the projection plane) on which the projector is disposed. The projector 100 may determine the size and position of the generated projection screen area using at least one sensor.

According to an embodiment, in operation 1710, the projector 100 may irradiate IR to generate an IR irradiation area in a horizontal direction on a projection plane. The IR irradiation area may be an area obtained by extending the projection screen area by a predetermined margin length. For example, the IR irradiation area may be an area obtained by extending the projection screen area by +5% length. Further, the projector 100 may generate an IR irradiation area by irradiating IR at a predetermined length apart in a vertical direction from the projection plane. For example, the projector 100 may irradiate IR at a distance of 3mm to 7mm in a vertical direction from the projection plane, but the disclosure is not limited thereto. The projector 100 may irradiate IR with a beam width of 1mm to 2mm, but the disclosure is not limited thereto.

According to an embodiment, in operation 1720, the projector 100 may determine whether IR reflection is detected in the IR irradiation area in a predetermined (e.g., specified) operation mode. The predetermined operation mode may be an operation mode for the projector 100 to detect IR reflection by an object other than the user touch in the IR irradiation area. The predetermined operation mode may be automatically entered after powering on the projector 100 or manually entered by a user input to set the user touch area, but the disclosure is not limited thereto. In case that IR reflection is detected, the process may move to operation 1730 and, based on IR reflection being not detected, the process may move to operation 1740. According to an embodiment, the projector 100 may detect IR reflection by detecting a luminance component equal to or greater than a predetermined threshold from an image sensing the IR irradiation area by at least one sensor. For example, the predetermined threshold may be set to a luminance component of 50 or more, but it is understood by those skilled in the art that it is not limited thereto. According to an embodiment, the projector 100 may divide the IR irradiation area 1320 into a predetermined number of zones to determine a zone where IR reflection is detected and a direction in which IR reflection is detected.

According to an embodiment, in operation 1730, the projector 100 may adjust an IR irradiation angle of the IR emitter 130 or adjust a height of the IR emitter 130 so that IR reflection is not detected in the IR irradiation area. The IR emitter may include an IR laser module and an IR reflection module. The IR laser module may irradiate IR in a vertical direction. The IR reflection module may reflect the IR irradiated in the vertical direction by the IR laser module to the projection plane in a horizontal direction. According to an embodiment, the projector 100 may rotate the IR laser module about at least one axis including an X-axis and a Y-axis so that IR reflection is not detected in the IR irradiation area. According to an embodiment, based on IR reflection being detected in a horizontal direction, the projector 100 may rotate the IR laser module about the Y-axis so that IR reflection is not detected in the IR irradiation area. According to an embodiment, based on IR reflection being detected in a diagonal direction, the projector 100 may rotate the IR laser module about the X-axis and the Y-axis so that IR reflection is not detected in the IR irradiation area. According to an embodiment, the projector 100 may drive a 6-axis actuator to rotate the IR laser module about at least one axis including an X-axis and a Y-axis. According to an embodiment, the projector 100 may adjust a height of the IR emitter 130 so that IR reflection is not detected in the IR irradiation area. In other words, the projector 100 may adjust the height of the IR emitter 130 to increase the distance between the projection plane and the IR irradiation area so that IR reflection is not detected in the IR irradiation area. According to an embodiment, the projector 100 may move the IR reflection module along the Y-axis so that IR reflection is not detected in the IR irradiation area.

According to an embodiment, in operation 1740, the projector 100 may set an area corresponding to a projection screen area of the IR irradiation area where IR reflection is not detected in the predetermined operation mode as the user touch area.

According to an embodiment, in operation 1750, the projector 100 may detect the user touch through IR reflection detection in the set user touch area.

The method of operation of the projector 100 described above with reference to FIG. 17 may be performed in response to an operation of powering on the projector 100 or an operation of detecting movement of the projector 100. The movement of the projector 100 may be detected by an acceleration sensor, but the disclosure is not limited thereto.

According to an embodiment of the disclosure, a projector may include a projection unit projecting an image onto a projection plane, an infrared (IR) emitter generating an IR irradiation area in a horizontal direction on the projection plane, at least one sensor sensing the projection plane or the IR irradiation area, a memory storing at least one instruction, and at least one processor electrically connected to the projection unit, the IR emitter, the at least one sensor and the memory, and executing the at least one instruction. The at least one processor may determine whether IR reflection is detected in the IR irradiation area in a predetermined operation mode and, based on IR reflection being detected, control to adjust an irradiation angle of the IR emitter or adjust a height of the IR emitter so that IR reflection is not detected in the IR irradiation area.

According to an embodiment, the at least one processor may determine a size and a position of a projection screen area on the projection plane. The IR irradiation area may be an area obtained by extending the projection screen area by a predetermined margin length.

According to an embodiment, the at least one processor may set an area corresponding to a projection screen area of the IR irradiation area where IR reflection is not detected in the predetermined operation mode as a user touch area, and detect a user touch through IR reflection detection in the set user touch area.

According to an embodiment, the at least one processor may detect IR reflection by detecting a luminance component equal to or greater than a predetermined threshold from an image sensing the IR irradiation area by the at least one sensor.

According to an embodiment, the at least one processor may divide the IR irradiation area into a predetermined number of zones to determine a zone where IR reflection is detected and a direction in which IR reflection is detected.

According to an embodiment, the IR emitter may include an IR laser module for irradiating IR in a vertical direction and a 6-axis actuator rotating the IR laser module about at least one axis including an X-axis and a Y-axis. The at least one processor may control the 6-axis actuator to rotate the IR laser module about the at least one axis including the X-axis and the Y-axis so that IR reflection is not detected in the IR irradiation area.

According to an embodiment, the at least one processor may control the 6-axis actuator to rotate the IR laser module about the Y-axis so that IR reflection is not detected in the IR irradiation area based on IR reflection being detected in a horizontal direction, or control the 6-axis actuator to rotate the IR laser module about the X-axis and the Y-axis so that IR reflection is not detected in the IR irradiation area based on IR reflection being detected in a diagonal direction.

According to an embodiment, the IR emitter may include an IR reflection module reflecting IR irradiated in a vertical direction inside the IR emitter to the projection plane in a horizontal direction. The at least one processor may control the IR reflection module to move the IR reflection module along the Y-axis so that IR reflection is not detected in the IR irradiation area.

According to an embodiment, the at least one processor may control to adjust an irradiation angle of the IR emitter in response to an operation of powering on the projector or an operation of detecting movement of the projector.

According to an embodiment, the predetermined operation mode may be an operation mode for the projector to detect IR reflection by an object other than a user touch in the IR irradiation area.

Further, according to an embodiment of the disclosure, a method of operating a projector may include irradiating IR to generate an IR irradiation area in a horizontal direction on a projection plane, determining whether IR reflection is detected in the IR irradiation area in a predetermined operation mode, and based on IR reflection being detected, adjusting an irradiation angle of an IR emitter or adjusting a height of the IR emitter so that IR reflection is not detected in the IR irradiation area.

According to an embodiment, the method of operating the projector may further include determining a size and a position of a projection screen area on the projection plane. The IR irradiation area may be an area obtained by extending the projection screen area by a predetermined margin length.

According to an embodiment, the method of operating the projector may further include setting an area corresponding to a projection screen area of the IR irradiation area where IR reflection is not detected in the predetermined operation mode as a user touch area, and detecting a user touch through IR reflection detection in the set user touch area.

According to an embodiment, determining whether IR reflection is detected in the IR irradiation area may include detecting IR reflection by detecting a luminance component equal to or greater than a predetermined threshold from an image sensing the IR irradiation area by at least one sensor.

According to an embodiment, adjusting the IR irradiation angle so that IR reflection is not detected in the IR irradiation area may include dividing the IR irradiation area into a predetermined number of zones to determine a zone where IR reflection is detected and a direction in which IR reflection is detected.

According to an embodiment, the IR emitter may include an IR laser module for irradiating IR in a vertical direction. Adjusting the IR irradiation angle so that IR reflection is not detected in the IR irradiation area may include rotating the IR laser module about at least one axis including an X-axis and a Y-axis so that IR reflection is not detected in the IR irradiation area.

According to an embodiment, adjusting the IR irradiation angle so that IR reflection is not detected in the IR irradiation area may include at least one of rotating the IR laser module about the Y-axis so that IR reflection is not detected in the IR irradiation area based on IR reflection being detected in a horizontal direction, and rotating the IR laser module about the X-axis and the Y-axis so that IR reflection is not detected in the IR irradiation area based on IR reflection being detected in a diagonal direction.

According to an embodiment, the IR emitter may include a 6-axis actuator rotating the IR laser module about at least one axis including an X-axis and a Y-axis. Adjusting the IR irradiation angle so that IR reflection is not detected in the IR irradiation area may include driving the 6-axis actuator to rotate the IR laser module about at least one axis including an X-axis and a Y-axis.

According to an embodiment, the IR emitter may include an IR reflection module reflecting IR irradiated in a vertical direction inside the IR emitter to the projection plane in a horizontal direction. Adjusting the IR irradiation angle so that IR reflection is not detected in the IR irradiation area may include moving the IR reflection module along the Y-axis so that IR reflection is not detected in the IR irradiation area.

According to an embodiment, the method of operating the projector may be performed in response to an operation of powering on the projector or an operation of detecting movement of the projector. The predetermined operation mode may be an operation mode for the projector to detect IR reflection by an object other than a user touch in the IR irradiation area.

The electronic device according to various embodiments of the disclosure may be one of various types of electronic devices. The electronic devices may include, for example, a display device, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. As used herein, the singular forms “a,” “an,” and “the” are intended to include the plural forms as well, unless the context clearly indicates otherwise. As used herein, the term 'and/or’ should be understood as encompassing any and all possible combinations by one or more of the enumerated items. As used herein, the terms “include,” “have,” and “comprise” are used merely to designate the presence of the feature, component, part, or a combination thereof described herein, but use of the term does not exclude the likelihood of presence or adding one or more other features, components, parts, or combinations thereof. As used herein, each of such phrases as "A or B," "at least one of A and B," “at least one of A or B,” "A, B, or C," "at least one of A, B, and C," and “at least one of A, B, or C,” may include all possible combinations of the items enumerated together in a corresponding one of the phrases. As used herein, such terms as "1st" and "2nd," or “first” and "second" may be used to simply distinguish a corresponding component from another, and does not limit the components in other aspect (e.g., importance or order).

As used herein, the term “part” or "module" may include a unit implemented in hardware, software, or firmware, and may interchangeably be used with other terms, for example, "logic," "logic block," "part," or "circuitry". A part or module may be a single integral component, or a minimum unit or part thereof, adapted to perform one or more functions. For example, according to an embodiment, ‘part’ or ‘module’ may be implemented in a form of an application-specific integrated circuit (ASIC).

As used in various embodiments of the disclosure, the term “if” may be interpreted as “when,” “upon,” “in response to determining,” or “in response to detecting,” depending on the context. Similarly, “if A is determined” or “if A is detected” may be interpreted as “upon determining A” or “in response to determining A”, or “upon detecting A” or “in response to detecting A”, depending on the context.

The program executed by the projector 100 described herein may be implemented as a hardware component, a software component, and/or a combination thereof. The program may be executed by any system capable of executing computer-readable instructions.

The software may include computer programs, codes, instructions, or combinations of one or more thereof and may configure the processing device as it is operated as desired or may instruct the processing device independently or collectively. The software may be implemented as a computer program including instructions stored in computer-readable storage media. The computer-readable storage media may include, e.g., magnetic storage media (e.g., read-only memory (ROM), random-access memory (RAM), floppy disk, hard disk, etc.) and an optically readable media (e.g., CD-ROM or digital versatile disc (DVD). Further, the computer-readable storage media may be distributed to computer systems connected via a network, and computer-readable codes may be stored and executed in a distributed manner. The computer program may be distributed (e.g., downloaded or uploaded) via an application store (e.g., Play Store™), directly between two UEs (e.g., smartphones), or online. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. A projector comprising:
a projection unit comprising circuitry and configured to project an image onto a projection plane;
an infrared (IR) emitter comprising circuitry and configured to generate an IR irradiation area in a horizontal direction on the projection plane;
at least one sensor configured to sense the projection plane or the IR irradiation area;
a memory storing at least one instruction; and
at least one processor, comprising processing circuitry, electrically connected to the projection unit, the IR emitter, the at least one sensor and the memory, and individually and/or collectively, configured to execute the at least one instruction, and to cause the projector to:
determine whether IR reflection is detected in the IR irradiation area in a specified operation mode; and
based on IR reflection being detected, control the projector to adjust an irradiation angle of the IR emitter or adjust a height of the IR emitter so that IR reflection is not detected in the IR irradiation area.

2. The projector of claim 1, wherein at least one processor, individually and/or collectively, is configured to cause the projector to determine a size and a position of a projection screen area on the projection plane, and wherein the IR irradiation area includes an area obtained by extending the projection screen area by a specified margin length.

3. The projector of claim 1, wherein at least one processor, individually and/or collectively, is configured to cause the projector to:
set an area corresponding to a projection screen area of the IR irradiation area where IR reflection is not detected in the specified operation mode as a user touch area; and
detect a user touch through IR reflection detection in the set user touch area.

4. The projector of claim 1, wherein at least one processor, individually and/or collectively, is configured to cause the projector to detect IR reflection by detecting a luminance component equal to or greater than a specified threshold from an image sensing the IR irradiation area by the at least one sensor.

5. The projector of claim 1, wherein at least one processor, individually and/or collectively, is configured to divide the IR irradiation area into a specified number of zones to determine a zone where IR reflection is detected and a direction in which IR reflection is detected.

6. The projector of claim 5, wherein the IR emitter includes an IR laser module including circuitry configured to irradiate IR in a vertical direction and a 6-axis actuator configured to rotate the IR laser module about at least one axis including an X-axis and a Y-axis, and wherein at least one processor, individually and/or collectively, is configured to cause the projector to control the 6-axis actuator to rotate the IR laser module about the at least one axis including the X-axis and the Y-axis so that IR reflection is not detected in the IR irradiation area.

7. The projector of claim 6, wherein at least one processor, individually and/or collectively, is configured to cause the projector to:
based on IR reflection being detected in a horizontal direction, control the 6-axis actuator to rotate the IR laser module about the Y-axis so that IR reflection is not detected in the IR irradiation area; or
based on IR reflection being detected in a diagonal direction, control the 6-axis actuator to rotate the IR laser module about the X-axis and the Y-axis so that IR reflection is not detected in the IR irradiation area.

8. The projector of claim 1, wherein the IR emitter includes an IR reflection module comprising an IR reflective material configured to reflect IR irradiated in a vertical direction inside the IR emitter to the projection plane in a horizontal direction, and wherein at least one processor, individually and/or collectively, is configured to cause the projector to control the IR reflection module to move the IR reflection module along the Y-axis so that IR reflection is not detected in the IR irradiation area.

9. The projector of claim 1, wherein at least one processor, individually and/or collectively, is configured to cause the projector to control to adjust an irradiation angle of the IR emitter in response to an operation of powering on the projector or an operation of detecting movement of the projector.

10. The projector of claim 1, wherein the specified operation mode includes an operation mode for the projector to detect IR reflection by an object other than a user touch in the IR irradiation area.

11. A method of operating a projector, comprising:
irradiating IR to generate an IR irradiation area in a horizontal direction on a projection plane;
determining whether IR reflection is detected in the IR irradiation area in a specified operation mode; and
based on IR reflection being detected, adjusting an irradiation angle of an IR emitter or adjusting a height of the IR emitter so that IR reflection is not detected in the IR irradiation area.

12. The method of claim 11, further comprising determining a size and a position of a projection screen area on the projection plane, wherein the IR irradiation area includes an area obtained by extending the projection screen area by a specified margin length.

13. The method of claim 11, further comprising:
setting an area corresponding to a projection screen area of the IR irradiation area where IR reflection is not detected in the specified operation mode as a user touch area; and
detecting a user touch through IR reflection detection in the set user touch area.

14. The method of claim 11, wherein determining whether IR reflection is detected in the IR irradiation area includes detecting IR reflection by detecting a luminance component equal to or greater than a specified threshold from an image sensing the IR irradiation area by at least one sensor.

15. The method of claim 11, wherein adjusting the IR irradiation angle so that IR reflection is not detected in the IR irradiation area includes dividing the IR irradiation area into a specified number of zones to determine a zone where IR reflection is detected and a direction in which IR reflection is detected.

16. The method of claim 15, wherein the IR emitter includes an IR laser module including circuitry and configured to radiate IR in a vertical direction, and wherein adjusting the IR irradiation angle so that IR reflection is not detected in the IR irradiation area includes rotating the IR laser module about at least one axis including an X-axis and a Y-axis so that IR reflection is not detected in the IR irradiation area.

17. The method of claim 16, wherein adjusting the IR irradiation angle so that IR reflection is not detected in the IR irradiation area includes:
based on IR reflection being detected in a horizontal direction, rotating the IR laser module about the Y-axis so that IR reflection is not detected in the IR irradiation area; and
based on IR reflection being detected in a diagonal direction, rotating the IR laser module about the X-axis and the Y-axis so that IR reflection is not detected in the IR irradiation area.

18. The method of claim 16, wherein the IR emitter includes a 6-axis actuator configured to rotate the IR laser module about at least one axis including an X-axis and a Y-axis, and wherein adjusting the IR irradiation angle so that IR reflection is not detected in the IR irradiation area includes driving the 6-axis actuator to rotate the IR laser module about at least one axis including an X-axis and a Y-axis.

19. The method of claim 11, wherein the IR emitter includes an IR reflection module comprising an IR reflective material configured to reflect IR irradiated in a vertical direction inside the IR emitter to the projection plane in a horizontal direction, and wherein adjusting the IR irradiation angle so that IR reflection is not detected in the IR irradiation area includes moving the IR reflection module along the Y-axis so that IR reflection is not detected in the IR irradiation area.

20. The method of claim 11, wherein the method of operating the projector is performed in response to an operation of powering on the projector or an operation of detecting movement of the projector, and wherein the specified operation mode includes an operation mode for the projector to detect IR reflection by an object other than a user touch in the IR irradiation area.
